(19) United States
(12) Patent Application Publication
(10) Pub. No.: US 2011/0032963 A1
(43) Pub. Date: Feb. 10, 2011

(54) Eu-containing inorganic compound, luminescent composition and luminescent body containing the same, solid laser device, and light emitting device

(75) Inventors: Masayuki Suzuki, Ashigarakami-gun (JP); Masahiro Takata, Ashigarakami-gun (JP); Junichi Mori, Minamiashigara-shi (JP); Tomotake Ikada, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/709,789

(22) Filed: Feb. 23, 2007

(30) Foreign Application Priority Data
Feb. 23, 2006 (JP) 2006-046524
Feb. 20, 2007 (JP) 2007-039098

(51) Int. Cl. H01S 3/16; C09K 11/77; C09K 11/02; H01J 1/62

(52) U.S. Cl. 372/39; 252/301.4 R; 252/301.36; 313/483

(57) ABSTRACT

An Eu-containing inorganic compound has a polycrystal structure, in which Eu has been doped into a matrix garnet type compound and has formed a solid solution in the matrix garnet type compound. A doping concentration of Eu occupying at an eight-coordination site of the garnet structure falls within the range of more than 0.5 mol % to 50.0 mol %, inclusive. The doping concentration of Eu occupying at the eight-coordination site of the garnet structure should preferably fall within the range of 5.0 mol % to 30.0 mol %.

### BACKGROUND OF THE INVENTION

1. Field of the Invention

This invention relates to an Eu-containing inorganic compound, in which Eu has been doped into a matrix garnet type compound and has formed a solid solution. This invention also relates to a luminescent composition and a luminescent body, each of which contains the Eu-containing inorganic compound. This invention further relates to a solid laser device and a light emitting device, each of which utilizes the luminescent body.

2. Description of the Related Art

Solid laser devices provided with a solid laser medium, which is constituted of a solid laser crystal having been doped with only Eu ions as luminescence center ions, and an exciting light source for producing exciting light for exciting the solid laser medium have been disclosed in, for example, patent literatures 1 and 2. The solid laser devices having the constitutions described above are capable of producing laser beams having wavelengths falling within the visible light wavelength range of 579 nm to 599 nm. Also, a constitution provided with a wavelength converting device, in which a produced laser beam having a wavelength of, for example, 589 nm is subjected to wavelength conversion so as to yield an ultraviolet laser beam having a wavelength of 295 nm, has been disclosed in, for example, the patent literature 1.

In the patent literatures 1 and 2, nothing is specifically described with respect to an Eu doping concentration. Also, in the patent literatures 1 and 2, nothing is described with respect to relationship between the Eu doping concentration and luminescence characteristics, optimization of the Eu doping concentration, or the like.

Further, it will be a correct interpretation that, unless otherwise specified, the term “crystal” is thought to mean the single crystal. In the patent literatures 1 and 2, nothing is described with respect to a polycrystal. Therefore, it is interpreted that, in the patent literatures 1 and 2, only the single crystal solid laser media are described.

As candidate materials for matrix compounds to be doped with Eu, garnet type compounds, such as Y₃Al₅O₁₂ (YAG), may be mentioned for their good thermal stability.

Table 1 shown below lists known literatures (non-patent literatures 3 to 17) concerning fundamental studies on single crystals of Eu-doped YAG (Eu:YAG) and a polycrystal ceramic material of Eu:YAG. Table 1 also shows the Eu doping concentrations (unless otherwise specified, in units of mol %) described in the literatures. Of the literatures listed in Table 1, only the non-patent literature 5 reports the study on the polycrystal ceramic material (transparent ceramic material). All of the other non-patent literatures listed in Table 1 report the studies on the single crystals.

As shown in Table 1, only a few reports have been made with respect to the fundamental studies on Eu:YAG, and the majority of the fundamental studies concern the single crystals.

A single crystal Eu:YAG compound, in which the Eu doping concentration is at least 10 mol %, has not been reported in the non-patent literatures other than the non-patent literature 3. In the study having been reported in the non-patent literature 3, single crystal Eu:YAG compounds, in which the Eu doping concentration falls within the range of approximately 0.5 mol % to approximately 65 mol %, are prepared by use of a flux technique. In the study having been reported in the non-patent literature 3, evaluation has been made with respect to the luminescence characteristics of the single crystal Eu:YAG compounds, and FIG. 3 shows a graph showing the relationship between the Eu doping concentration and the fluorescence intensity at a wavelength of 591 nm. In the study having been reported in the non-patent literature 3, the exciting light is described as being “long wavelength ultraviolet light,” and the wavelength of the exciting light is not clear. However, it is presumed that the exciting light utilized in the study having been reported in the non-patent literature 3 will be the ultraviolet light having wavelengths of 315 nm to 400 nm, which ultraviolet light is referred to as “UV-A.”

The Eu doping concentration illustrated in FIG. 3 in the non-patent literature 3 is not in units of mol %. For comparison, FIG. 15B shows the data in the non-patent literature 3, which data have been converted into the data in units of mol %, and the data having been obtained in Example 1 in accordance with the present invention, which will be described later. As illustrated in FIG. 15B, the data in the non-patent literature 3 show that the luminescence is produced over a wide range of Eu doping concentration of 0.5 to 65 mol %, and that the optimum Eu doping concentration is 10 mol %.

As described above, the high concentration Eu doping is reported in the non-patent literature 3. However, after the report was made in the non-patent literature 3, nothing has been reported with respect to a single crystal Eu:YAG compound, in which the Eu doping concentration is higher than 10 mol %. Thus it is not always possible to produce a single crystal Eu:YAG compound, in which the Eu doping concentration is high. In cases where Eu is to be doped in YAG, a part of Y³⁺ ions at an A site are substituted by Eu³⁺ ions through the formation of a solid solution. However, an ionic radius of the Eu³⁺ ions is larger than the ionic radius of the Y³⁺ ions. Therefore, as described above, it is not always possible to produce a single crystal Eu:YAG compound, in which the Eu doping concentration is high.

FIG. 20 is a graph showing relationships between ionic radiuses of rare earth elements, which are contained in garnet type compounds, and lattice constants of the garnet type compounds. FIG. 20 shows the results of adjustments made by the inventors principally in accordance with open data of U.S. International Centre for Diffraction Data (ICDD) and data described in a non-patent literature 1.

As for rare earth aluminum garnet type compounds (RE₃Al₅O₁₂), FIG. 20 indicates that only the compounds containing the rare earth elements having an ionic radius of at most 0.106 are present, and that nothing has been reported with regard to the compounds containing Eu, Sm, Nd, Pr, Ce, and La, which have an ionic radius larger than 0.106. It is indicated from FIG. 20 that it is not always possible to form the solid solution of Eu, which has a large ionic radius, in YAG.

FIG. 21 is a graph showing relationships between ionic radiuses of rare earth element ions, which are to be doped in YAG, and segregation coefficients of the rare earth element ions. The relationships shown in FIG. 21 are described in, for example, a non-patent literature 2. In cases where the ionic radius of Eu is applied to the graph of FIG. 21, it is found that the coefficient of segregation at the time of the doping of Eu in YAG is markedly small and is approximately 0.5.

As described above, it is not always possible to produce the single crystal Eu:YAG compound, in which the Eu doping concentration is high. Also, it is not always possible to obtain reliably the single crystal Eu:YAG compound, in which the Eu doping concentration is high and which has a desired composition. Further, the production cost is not capable of being kept low.

From the view point of the easiness of the Eu doping at a high concentration and from the viewpoint of the production cost, the Eu:YAG compound should preferably have a polycrystal structure. As described above, of the non-patent literatures listed in Table 1, only the non-patent literature 5 reports the study on the polycrystal Eu:YAG compound, in which the Eu doping concentration is 0.5 mol %.

[Patent literature 1] Japanese Unexamined Patent Publication No. 2002-344049
[Patent literature 2] Japanese Unexamined Patent Publication No. 2002-353542
[Non-patent literature 1] C. D. Brandle, et al., J. Cryst. Growth 20 (1973) 1-5
[Non-patent literature 2] Akio Ikesue, et al., Laser Research, Vol. 27, No. 9 (1999) 593-598

TABLE 1

| | Non-patent literature Eu doping concentration | Eu doping concentration |
|---|---|---|
| 3. | L. G. Van Uitert and L. F. Johnson, | At least 50%-Eu YAG |
| | J. Chem. Phys., 44 (1966) 3514. | |
| 4. | M. Mitsunaga and N. Uesugi, | No description on doping |
| | J. Lumin., 48 & 49 (1991) 459. | concentration |
| 5. | M. Sekita, H. Haneda, S. Shirasaki and T. Yanagitani, | Transparent ceramic material, |
| | J. Appl. Phys., 69 (1991) 3709. | 0.5%-Eu YAG |
| 6. | D. Ravichandran, R. Roy, A. G. Chakhovskoi, C. E. Hunt, | 1%-, 2%-Eu YAG |
| | W. B. White and S. Erdei, J. Lumin., 71 (1997) 291. | |
| 7. | S. K. Ruan, J. G. Zhou, A. M. Zhong, J. F. Duan, X. B. | 4%-Eu YAG |
| | Yang and M. Z. Su, J. Alloy. Compd. 275-277 (1998) 72. | |
| 8. | Y. C. Kang, Y. S. Chung and S. B. Park, | 0.4%- to 2.1%-Eu YAG |
| | J. Am. Ceram. Soc., 82 (1999) 2056. | |
| 9. | S. Shikao and W. Jiye, J. Alloy. Compd, 327 (2001) 82. | 4%-, 6%-, 10%-Eu YAG |
| 10. | Y. H. Zhou, J. Lin, S. B. Wang and H. J. Zhang, | 1%-Eu YAG |
| | Opt. Mat., 20 (2002) 13. | |
| 11. | Y. H. Zhou, J. Lin, M. Yu, S. M. Han, S. B. Wang and | 1%-Eu YAG |
| | H. J. Zhang, Mater. Res. Bull., 38 (2003) 1289. | |
| 12. | J. J. Zhang, J. W. Ning, X. J. Lieu, Y. B. Pan, L. P. Huang, | 5%-Eu YAG |
| | J. Mater. Sci. Lett., 22 (2003) 13. | |
| 13. | Y. R. Shen, C. M. Li, V. C. Costa and K. L. Bray, | 0.1 wt %-Eu YAG |
| | Phys. Rev. B, 68 (2003) 014101. | |
| 14. | W. T. Hsu, W. H. Wu and C. H. Lu, | 5%-Eu YAG |
| | Mater. Sci. and Eng. B, 104 (2003) 40. | |
| 15. | C. H. Lu, W. T. Hsu, J. Dhanaraj and R. Jagannathan, | 5%-Eu YAG |
| | J. Euro. Ceram. Soc., 24 (2004) 3723. | |
| 16. | C. H. Lu and C. H. Huang, Chem. Lett., 33 (2004) 1568. | Gd-doped Eu:YAG, |
| | | Gd/Eu = 0/5, 3/5, 5/5, 7/5 |
| 17. | D. Boyer, G. B. Chadeyron and R. Mahiou, | 2%-Eu YAG |
| | Opt. Mater., 26 (2004) 101. | |

As described above, little basic research has heretofore been conducted with regard to the polycrystal Eu:YAG compound. With regard to the polycrystal Eu:YAG compound, only the non-patent literature 5 reports the study on the polycrystal Eu:YAG compound, in which the Eu doping concentration is 0.5 mol %. In the non-patent literature 5, simple luminescence data, and the like, are described, and nothing is studied with respect to the relationship between the Eu doping concentration and the luminescence characteristics, optimization of the Eu doping concentration, or the like. Also, in the non-patent literatures 3 to 17 listed in Table 1, in which the fundamental studies on Eu:YAG are reported, nothing is described with respect to application of Eu:YAG, which has the single crystal structure or the polycrystal structure, to solid laser media, or the like.

Besides the cases of Eu:YAG, the above circumstances occur with the overall systems, in which Eu is doped into the matrix garnet type compound.

### SUMMARY OF THE INVENTION

The primary object of the present invention is to clarify relationship between an Eu doping concentration and luminescence characteristics of a garnet type Eu-containing inorganic compound having a polycrystal structure and to optimize the Eu doping concentration in the garnet type Eu-containing inorganic compound having a polycrystal structure. Another object of the present invention is to provide a garnet type Eu-containing inorganic compound having a polycrystal structure, which compound exhibits good luminescence characteristics through optimization of the Eu doping concentration. A further object of the present invention is to provide a luminescent body, a solid laser device, and a light emitting device, each of which utilizes the garnet type Eu-containing inorganic compound having a polycrystal structure.

A still further object of the present invention is to provide a novel idea of material designing for a luminescent inorganic compound having a single crystal structure or a polycrystal structure, which compound contains an arbitrary luminescent rare earth element, besides an Eu doping system. Another object of the present invention is to provide a luminescent inorganic compound, which has been designed in accordance with the novel idea of material designing. A further object of the present invention is to provide a process for producing the luminescent inorganic compound.

The present invention provides an Eu-containing inorganic compound having a polycrystal structure, in which Eu has been doped into a matrix garnet type compound and has formed a solid solution in the matrix garnet type compound,

wherein a doping concentration of Eu occupying at an eight-coordination site of the garnet structure falls within the range of more than 0.5 mol % to 50.0 mol %, inclusive.

The Eu-containing inorganic compound in accordance with the present invention should preferably be modified such that the doping concentration of Eu occupying at the eight-coordination site of the garnet structure falls within the range of 5.0 mol % to 30.0 mol %.

The term “Eu doping concentration” as used herein means the doping concentration of Eu occupying at the eight-coordination site of the garnet structure.

The Eu-containing inorganic compound in accordance with the present invention may be modified such that the Eu-containing inorganic compound is a garnet type compound, which may be represented by the general formula:

(A(III)₁₋ₓEuₓ)₃B(III)₂C(III)₃O₁₂

wherein each of the Roman numerals in the parentheses represents the valence number of ion,

A represents the element at the A site and represents at least one kind of element selected from the group consisting of Y, Sc, In, and trivalent rare earth elements of La, Ce, Pr, Nd, Sm, Gd, Tb, Dy, Ho, Er, Tm, Yb, and Lu,

B represents the element at the B site and represents at least one kind of element selected from the group consisting of Al, Sc, Ga, Cr, In, and trivalent rare earth elements of La, Ce, Pr, Nd, Sm, Eu, Gd, Tb, Dy, Ho, Er, Tm, Yb, and Lu,

C represents the element at the C site and represents at least one kind of element selected from the group consisting of Al and Ga, and

O represents the oxygen atom.

In cases where the Eu-containing inorganic compound in accordance with the present invention is the garnet type compound, which may be represented by the general formula shown above, the matrix garnet type compound may be Y₃Al₅O₁₂.

The present invention also provides a first luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,

the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,

the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw takes an approximately predetermined value regardless of the doping concentration of the luminescent rare earth element,

the doping concentration of the luminescent rare earth element in the luminescent inorganic compound being set at a value falling within the range of the doping concentration of the luminescent rare earth element, in which range the light absorption intensity ratio Pf/Pw takes an approximately predetermined value regardless of the doping concentration of the luminescent rare earth element.

The present invention further provides a second luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,

the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,

the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw is approximately in proportion to the doping concentration of the luminescent rare earth element,

the doping concentration of the luminescent rare earth element in the luminescent inorganic compound being set at a value falling within the range of 0.5 Ne mol % to 2.0 Ne mol %, wherein Ne mol % represents the highest doping concentration of the luminescent rare earth element in the range of the doping concentration of the luminescent rare earth element, in which range the light absorption intensity ratio Pf/Pw is approximately in proportion to the doping concentration of the luminescent rare earth element.

Each of the first and second luminescent inorganic compounds in accordance with the present invention may have a single crystal structure. Alternatively, each of the first and second luminescent inorganic compounds in accordance with the present invention may have a polycrystal structure.

The present invention still further provides a luminescent body, containing the Eu-containing inorganic compound in accordance with the present invention or the luminescent inorganic compound in accordance with the present invention, the luminescent body taking on the form of a molded body having been formed into a predetermined shape.

Incases where the Eu-containing inorganic compound in accordance with the present invention or the luminescent inorganic compound in accordance with the present invention is a laser substance capable of producing a laser beam by being excited by exciting light, the luminescent body in accordance with the present invention is capable of being utilized as the solid laser medium and is capable of furnishing a solid laser device in accordance with the present invention.

Specifically, the present invention also provides a solid laser device, comprising:

i) a solid laser medium constituted of a luminescent body in accordance with the present invention, which luminescent body is capable of producing a laser beam by being excited by exciting light, and

ii) an exciting light source for producing the exciting light to be irradiated to the solid laser medium.

The present invention further provides a light emitting device, comprising:

i) a luminescent body in accordance with the present invention, and

ii) an exciting light source for producing exciting light to be irradiated to the luminescent body.

With the present invention, the relationship between the Eu doping concentration and the luminescence characteristics of the garnet type Eu-containing inorganic compound having the polycrystal structure is clarified. Also, the optimum Eu doping concentration in the garnet type Eu-containing inorganic compound having the polycrystal structure is clarified. Further, the present invention provides the garnet type Eu-containing inorganic compound having the polycrystal structure, in which the Eu doping concentration falls within the range of more than 0.5 mol % to 50.0 mol %, inclusive, the range having not been reported in the past. Particularly, the present invention clarifies that a high luminescence intensity is capable of being obtained with the Eu doping concentration falling within the range of 5.0 mol % to 30.0 mol %. With the present invention, there is provided the garnet type Eu-containing inorganic compound having the polycrystal structure, which compound exhibits the good luminescence characteristics through the optimization of the Eu doping concentration.

The present invention will hereinbelow be described in further detail.

### BRIEF DESCRIPTION OF THE DRAWINGS

FIG. 1A is a diagram showing a scanning type electron microscope (SEM) photograph of a cross-section of an example of a polycrystal sintered body,

FIG. 1B is an image view showing a cross-section of a different example of a polycrystal sintered body,

FIG. 2A is a perspective view showing a particle having a truncated octahedral shape,

FIG. 2B is a perspective view showing a particle having a rhombic dodecahedral shape,

FIGS. 3A, 3B, 3C, and 3D are explanatory views showing how particles having a truncated octahedral shape fill a space,

FIGS. 4A, 4B, 4C, and 4D are explanatory views showing how a shape of a particle alters with the passage of reaction time in cases where a garnet type compound is formed with a hydrothermal synthesis technique,

FIG. 5 is an explanatory view showing an embodiment of the solid laser device in accordance with the present invention,

FIG. 6A is an explanatory view showing an example of design modification of the solid laser device in accordance with the present invention,

FIG. 6B is an explanatory view showing a different example of design modification of the solid laser device in accordance with the present invention,

FIG. 7A is a sectional view showing an embodiment of the light emitting device in accordance with the present invention, the view being taken in a thickness direction of a circuit base plate,

FIG. 7B is a plan view showing an example of design modification of the light emitting device in accordance with the present invention, the view being taken from the side of a light emitting element,

FIG. 8 is a graph showing results of powder X-ray diffraction measurement, which results were obtained in Example 1,

FIG. 9 is a graph showing results of powder X-ray diffraction measurement, which results were obtained in Example 1,

FIG. 10 is a graph showing relationship between an Eu doping concentration and a lattice constant, which relationship was obtained in Example 1,

FIG. 11A is a graph showing an emission spectrum, which was obtained with 1.0% Eu:YAG (a sample 2),

FIG. 11B is a graph showing an excitation spectrum for 1.0% Eu:YAG (the sample 2),

FIG. 12 is a graph showing a transmission absorption spectrum of the 1.0% Eu:YAG single crystal,

FIG. 13 is a graph showing results of measurement of a fluorescence life time of 1.0% Eu:YAG (the sample 2),

FIG. 14A is a graph showing an emission spectrum, which was obtained with 10.0% Eu:YAG (a sample 8),

FIG. 14B is a graph showing an excitation spectrum for 10.0% Eu:YAG (the sample 8),

FIG. 15A is a graph showing relationship between the Eu doping concentration and an luminescence intensity at a wavelength of 589 nm with an excitation wavelength being set at 394 nm, which relationship was obtained in Example 1 (polycrystal),

FIG. 15B is a graph showing the relationships between the Eu doping concentration and the luminescence intensity at a wavelength of 589 nm with the excitation wavelength being set at 394 nm, which relationships were obtained in Example 1 (polycrystal) and in FIG. 3 (single crystal) in the non-patent literature 3,

FIG. 16 is a graph showing relationship between the Eu doping concentration and a light absorption intensity ratio Pf/Pw between two excitation peak wavelengths (394 nm and 240 nm), which relationship was obtained in Example 1,

FIG. 17 is a diagram showing an SEM cross-section photograph of 10.0% Eu:YAG obtained in Example 5,

FIG. 18 is a graph showing results of powder X-ray diffraction measurement, which results were obtained with 10.0% Eu:YAG obtained in Example 5,

FIG. 19 is a graph showing an emission spectrum, which was obtained with 10.0% Eu:YAG obtained in Example 5,

FIG. 20 is a graph showing relationships between ionic radiuses of rare earth elements, which are contained in garnet type compounds, and lattice constants of the garnet type compounds, and

FIG. 21 is a graph showing relationships between ionic radiuses of rare earth element ions, which are to be doped in YAG, and segregation coefficients of the rare earth element ions.

### DETAILED DESCRIPTION OF THE INVENTION

### Eu-Containing Inorganic Compound

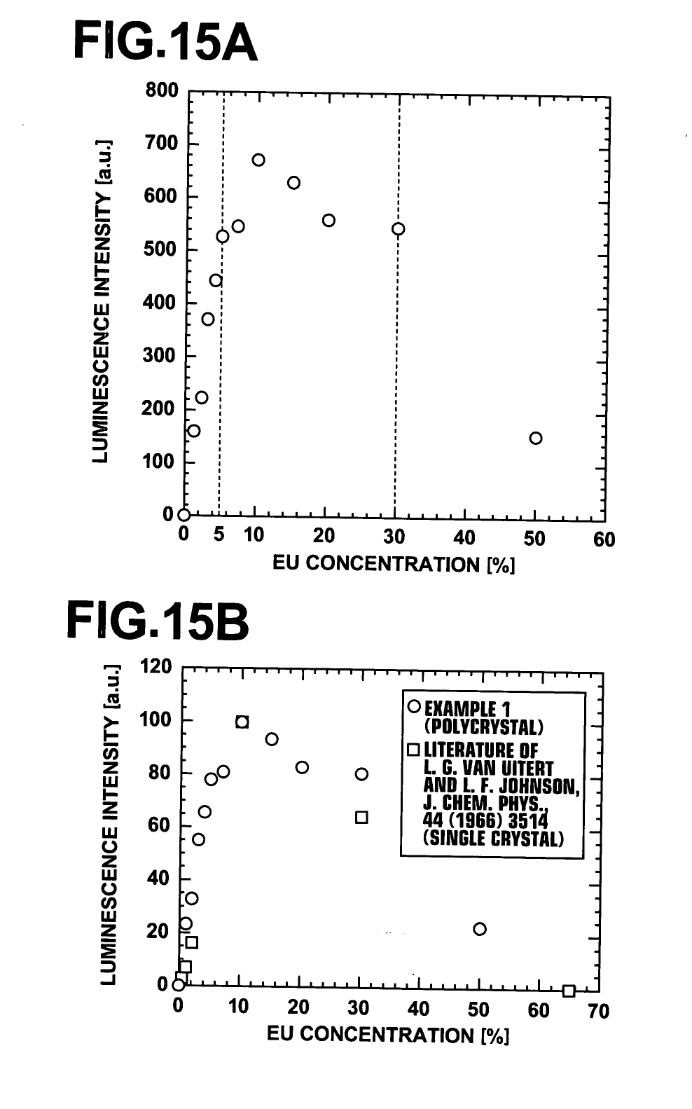

The inventors conducted extensive research on the garnet type of the Eu-containing inorganic compound having a polycrystal structure, particularly on the relationship between the doping concentration of Eu occupying at the eight-coordination site of the garnet structure and the luminescence characteristics of the garnet type of the Eu-containing inorganic compound having the polycrystal structure. The inventors thus found that the Eu doping concentration falling within the range of more than 0.5 mol % to 50.0 mol %, inclusive, is capable of being accomplished. The inventors particularly found that a high luminescence intensity is capable of being obtained in cases where the Eu doping concentration falls within the range of 5.0 mol % to 30.0 mol %. (Reference may be made to FIG. 15A for Example 1.)

Specifically, the present invention provides the Eu-containing inorganic compound having the polycrystal structure, in which Eu has been doped into the matrix garnet type compound and has formed the solid solution in the matrix garnet type compound,

wherein the doping concentration of Eu occupying at the eight-coordination site of the garnet structure falls within the range of more than 0.5 mol % to 50.0 mol %, inclusive.

The Eu-containing inorganic compound in accordance with the present invention should preferably be modified such that the doping concentration of Eu occupying at the eight-coordination site of the garnet structure falls within the range of 5.0 mol % to 30.0 mol %.

The Eu-containing inorganic compound in accordance with the present invention need not necessarily be subjected to co-doping of an element other than Eu as the luminescence center ions. Therefore, the Eu-containing inorganic compound in accordance with the present invention may be modified such that the Eu-containing inorganic compound substantially contains Eu alone as luminescence center ions.

The Eu-containing inorganic compound in accordance with the present invention may contain inevitable impurities. The term “substantially containing Eu alone as luminescence center ions” as used herein means that the Eu-containing inorganic compound in accordance with the present invention contains Eu alone as the luminescence center ions, except for inevitable impurities. However, when necessary, the Eu-containing inorganic compound in accordance with the present invention may be subjected to the co-doping of an element other than Eu as the luminescence center ions.

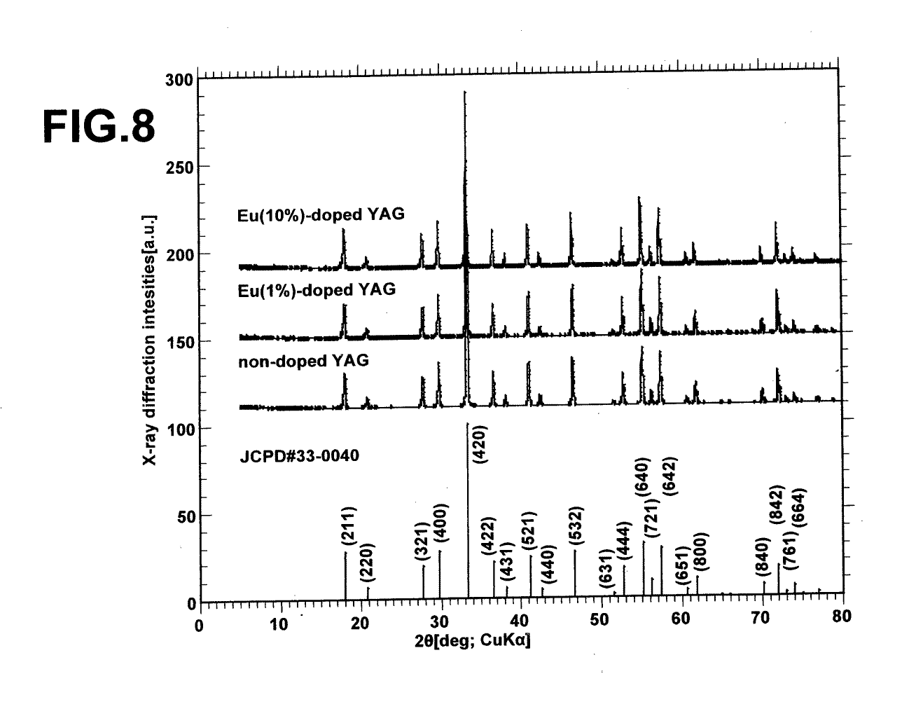

The Eu-containing inorganic compound in accordance with the present invention is capable of having a single phase structure over the entire range of the Eu doping concentration of more than 0.5 mol % to 50.0 mol %, inclusive. (Reference may be made to FIG. 8 for Example 1.) However, the Eu-containing inorganic compound in accordance with the present invention may contain a heterogeneous phase within a range such that the characteristics of the Eu-containing inorganic compound may not be affected adversely.

The Eu-containing inorganic compound in accordance with the present invention may be modified such that the Eu-containing inorganic compound is the garnet type compound, which may be represented by the general formula:

(A(III)₁₋ₓEuₓ)₃B(III)₂C(III)₃O₁₂

wherein each of the Roman numerals in the parentheses represents the valence number of ion,

A represents the element at the A site and represents at least one kind of element selected from the group consisting of Y, Sc, In, and trivalent rare earth elements of La, Ce, Pr, Nd, Sm, Gd, Tb, Dy, Ho, Er, Tm, Yb, and Lu,

B represents the element at the B site and represents at least one kind of element selected from the group consisting of Al, Sc, Ga, Cr, In, and trivalent rare earth elements of La, Ce, Pr, Nd, Sm, Eu, Gd, Tb, Dy, Ho, Er, Tm, Yb, and Lu,

C represents the element at the C site and represents at least one kind of element selected from the group consisting of Al and Ga, and

O represents the oxygen atom.

In the general formula shown above, x represents the value representing the number of mols of Eu. The value of x is determined in accordance with the Eu doping concentration. Specifically, the range of the Eu doping concentration of more than 0.5 mol % to 50.0 mol %, inclusive, corresponds to the range of 0.005<x≦0.5. Also, the range of the Eu doping concentration of 5.0 mol % to 30.0 mol % corresponds to the range of 0.05≦x≦0.3.

In cases where the Eu-containing inorganic compound in accordance with the present invention is the garnet type compound, which may be represented by the general formula shown above, the matrix garnet type compound may be, for example, Y₃Al₅O₁₂ (YAG).

With the present invention, the relationship between the Eu doping concentration and the luminescence characteristics of the garnet type Eu-containing inorganic compound having the polycrystal structure is clarified. Also, the optimum Eu doping concentration in the garnet type Eu-containing inorganic compound having the polycrystal structure is clarified. Further, the present invention provides the garnet type Eu-containing inorganic compound having the polycrystal structure, in which the Eu doping concentration falls within the range of more than 0.5 mol % to 50.0 mol %, inclusive, the range having not been reported in the past. Particularly, the present invention clarifies that a high luminescence intensity is capable of being obtained with the Eu doping concentration falling within the range of 5.0 mol % to 30.0 mol %. With the present invention, there is provided the garnet type Eu-containing inorganic compound having the polycrystal structure, which compound exhibits the good luminescence characteristics through the optimization of the Eu doping concentration.

The Eu-containing inorganic compound in accordance with the present invention has the polycrystal structure. Therefore, the Eu-containing inorganic compound in accordance with the present invention has the advantages over the inorganic compound having the single crystal structure in that the high concentration doping is capable of being achieved easily and in that the production cost is capable of being kept low.

The Eu-containing inorganic compound in accordance with the present invention is the laser substance capable of producing the laser beam by being excited by the exciting light and is capable of being utilized in a wide variety of use applications, such as the solid laser medium.

The Eu-containing inorganic compound in accordance with the present invention is capable of being excited by the exciting light having been produced by a conventional light source (e.g., a GaN type semiconductor laser or a ZnO type semiconductor laser). Also, with the Eu-containing inorganic compound in accordance with the present invention, Eu is capable of being doped at a high doping concentration. Further, in cases where the Eu-containing inorganic compound in accordance with the present invention is doped with Eu at a high doping concentration, little attenuation occurs with the luminescence intensity (i.e., little concentration quenching occurs). Furthermore, the Eu-containing inorganic compound in accordance with the present invention exhibits the sufficiently long fluorescence life time and is useful as the solid laser medium, and the like. (Reference may be made to Example 1.)

### “Luminescent Inorganic Compound”

As for the garnet type Eu-containing inorganic compound, the inventors have obtained findings (R1), (R2), and (R3) described below.

(R1) The garnet type Eu-containing inorganic compound has the characteristics such that:
the excitation spectrum, which represents the luminescence intensity at the highest luminescence peak wavelength within the visible light wavelength region with respect to the excitation wavelengths, has the plurality of the excitation peak wavelengths in the wavelength region shorter than 470 nm.

(R2) The garnet type Eu-containing inorganic compound has the characteristics such that:
in cases where the Eu doping concentration is set at various different values, and the calculation is made to find the light absorption intensity ratio Pf/Pw between the two excitation peak wavelengths, which are associated with the highest luminescence intensity and the second highest luminescence intensity among the plurality of the excitation peak wavelengths in the wavelength region shorter than 470 nm, wherein Pf represents the light absorption intensity at the excitation peak wavelength on the long wavelength side when the two excitation peak wavelengths, which are associated with the highest luminescence intensity and the second highest luminescence intensity, are compared with each other, and wherein Pw represents the light absorption intensity at the excitation peak wavelength on the short wavelength side when the two excitation peak wavelengths, which are associated with the highest luminescence intensity and the second highest luminescence intensity, are compared with each other,
the garnet type Eu-containing inorganic compound exhibits the range of the Eu doping concentration, in which range the light absorption intensity ratio Pf/Pw takes the approximately predetermined value regardless of the Eu doping concentration.

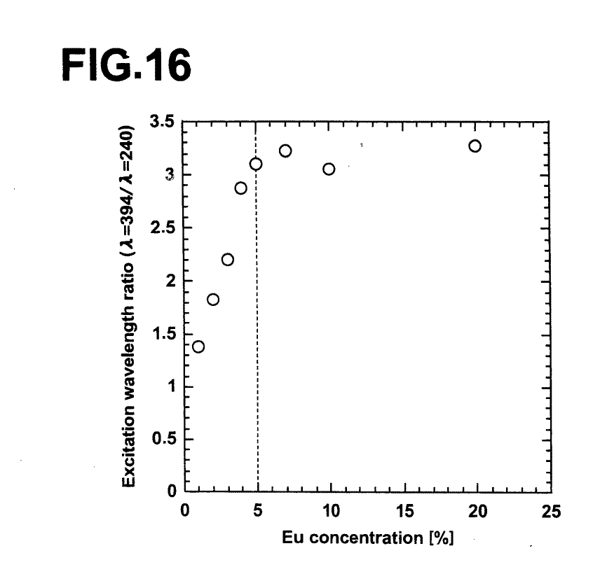

(R3) The garnet type Eu-containing inorganic compound has the characteristics such that:
the range of the Eu doping concentration, which range is associated with a high luminescence intensity, coincides with the range of the Eu doping concentration, in which range the light absorption intensity ratio Pf/Pw takes the approximately predetermined value regardless of the Eu doping concentration. (Reference may be made to FIG. 16 for Example 1.)

Also, as for the Eu-doped garnet compound, the inventors have obtained findings (R4) and (R5) described below.

(R4) The Eu-doped garnet compound has the characteristics such that:
incases where the Eu doping concentration is set at various different values, and the calculation is made to find the light absorption intensity ratio Pf/Pw between the two excitation peak wavelengths, which are associated with the highest luminescence intensity and the second highest luminescence intensity among the plurality of the excitation peak wavelengths in the wavelength region shorter than 470 nm, wherein Pf represents the light absorption intensity at the excitation peak wavelength on the long wavelength side when the two excitation peak wavelengths, which are associated with the highest luminescence intensity and the second highest luminescence intensity, are compared with each other, and wherein Pw represents the light absorption intensity at the excitation peak wavelength on the short wavelength side when the two excitation peak wavelengths, which are associated with the highest luminescence intensity and the second highest luminescence intensity, are compared with each other,
the Eu-doped garnet compound exhibits the range of the Eu doping concentration, in which range the light absorption intensity ratio Pf/Pw is approximately in proportion to the Eu doping concentration.

(R5) The Eu-doped garnet compound has the characteristics such that:
the range of the Eu doping concentration, which range is associated with a high luminescence intensity, coincides with the range of the Eu doping concentration of 0.5 Ne mol % to 2.0 Ne mol %, wherein Ne mol % represents the highest Eu doping concentration in the range of the Eu doping concentration, in which range the light absorption intensity ratio Pf/Pw is approximately in proportion to the Eu doping concentration.

### (Reference May be Made to FIG. 16 for Example 1.)

The inventors considered that, besides the garnet type Eu-containing inorganic compound, the findings (R1), (R2), (R3), (R4), and (R5) described above are also applicable to the material designing for arbitrary luminescent inorganic compounds, which contain substantially one kind of luminescent rare earth element alone as the luminescence center ions. Thus the present invention also provides the luminescent inorganic compounds described below and the processes for producing the luminescent inorganic compounds described below.

Specifically, the present invention also provides the first luminescent inorganic compound, which contains the luminescence center ions capable of being excited by the irradiation of the exciting light and capable of producing the luminescence having at least one luminescence peak wavelength in the visible light wavelength region of 400 nm to 700 nm, and which contains substantially one kind of luminescent rare earth element alone as the luminescence center ions,

the luminescent inorganic compound having the characteristics such that:
the excitation spectrum, which represents the luminescence intensity at the highest luminescence peak wavelength within the visible light wavelength region with respect to the excitation wavelengths, has the plurality of the excitation peak wavelengths in the wavelength region shorter than 470 nm,

the luminescent inorganic compound having the characteristics such that:
in cases where the doping concentration of the luminescent rare earth element is set at various different values, and the calculation is made to find the light absorption intensity ratio Pf/Pw between the two excitation peak wavelengths, which are associated with the highest luminescence intensity and the second highest luminescence intensity among the plurality of the excitation peak wavelengths in the wavelength region shorter than 470 nm, wherein Pf represents the light absorption intensity at the excitation peak wavelength on the long wavelength side when the two excitation peak wavelengths, which are associated with the highest luminescence intensity and the second highest luminescence intensity, are compared with each other, and wherein Pw represents the light absorption intensity at the excitation peak wavelength on the short wavelength side when the two excitation peak wavelengths, which are associated with the highest luminescence intensity and the second highest luminescence intensity, are compared with each other,
the luminescent inorganic compound exhibits the range of the doping concentration of the luminescent rare earth element, in which range the light absorption intensity ratio Pf/Pw takes the approximately predetermined value regardless of the doping concentration of the luminescent rare earth element,

the doping concentration of the luminescent rare earth element in the luminescent inorganic compound being set at the value falling within the range of the doping concentration of the luminescent rare earth element, in which range the light absorption intensity ratio Pf/Pw takes the approximately predetermined value regardless of the doping concentration of the luminescent rare earth element.

The term “exhibiting a range of a doping concentration of a luminescent rare earth element, in which range a light absorption intensity ratio Pf/Pw takes an approximately predetermined value regardless of a doping concentration of a luminescent rare earth element” as used herein means the characteristics satisfying a (requirement 1) and a (requirement 2) described below.

(Requirement 1) Within the aforesaid range of the doping concentration of the luminescent rare earth element, the light absorption intensity ratio Pf/Pw associated with each doping concentration falls within the range of 90% to 100% of the maximum value of the light absorption intensity ratio Pf/Pw with respect to the aforesaid range of the doping concentration of the luminescent rare earth element.

(Requirement 2) The range of the doping concentration, in which the aforesaid requirement 1 is satisfied, extends over the range of at least 10 mol %.

The present invention further provides the second luminescent inorganic compound, which contains the luminescence center ions capable of being excited by the irradiation of the exciting light and capable of producing the luminescence having at least one luminescence peak wavelength in the visible light wavelength region of 400 nm to 700 nm, and which contains substantially one kind of luminescent rare earth element alone as the luminescence center ions,

the luminescent inorganic compound having the characteristics such that:
the excitation spectrum, which represents the luminescence intensity at the highest luminescence peak wavelength within the visible light wavelength region with respect to the excitation wavelengths, has the plurality of the excitation peak wavelengths in the wavelength region shorter than 470 nm,

the luminescent inorganic compound having the characteristics such that:
in cases where the doping concentration of the luminescent rare earth element is set at various different values, and the calculation is made to find the light absorption intensity ratio Pf/Pw between the two excitation peak wavelengths, which are associated with the highest luminescence intensity and the second highest luminescence intensity among the plurality of the excitation peak wavelengths in the wavelength region shorter than 470 nm, wherein Pf represents the light absorption intensity at the excitation peak wavelength on the long wavelength side when the two excitation peak wavelengths, which are associated with the highest luminescence intensity and the second highest luminescence intensity, are compared with each other, and wherein Pw represents the light absorption intensity at the excitation peak wavelength on the short wavelength side when the two excitation peak wavelengths, which are associated with the highest luminescence intensity and the second highest luminescence intensity, are compared with each other,
the luminescent inorganic compound exhibits the range of the doping concentration of the luminescent rare earth element, in which range the light absorption intensity ratio Pf/Pw is approximately in proportion to the doping concentration of the luminescent rare earth element,

the doping concentration of the luminescent rare earth element in the luminescent inorganic compound being set at the value falling within the range of 0.5 Ne mol % to 2.0 Ne mol %, wherein Ne mol % represents the highest doping concentration of the luminescent rare earth element in the range of the doping concentration of the luminescent rare earth element, in which range the light absorption intensity ratio Pf/Pw is approximately in proportion to the doping concentration of the luminescent rare earth element.

How the value of Ne mol % is calculated will be described hereinbelow.

Specifically, the doping concentration of the luminescent rare earth element is plotted on the horizontal axis, and the light absorption intensity ratio Pf/Pw is plotted on the vertical axis. Also, in the region of the doping concentration of the luminescent rare earth element of at least 0.1 mol %, the concentration points of the doping concentration plotted on the horizontal axis are represented by n1, n2, n3, . . . in this order from the low concentration side. (Δn=n(m+1)−n(m)=1.0 mol %, where m represents a positive integer.)

Firstly, straight line approximation with the method of least squares is made with respect to the three points of n1, n2, and n3. Also, with respect to the straight line, the Poisson R value represented by the formula shown below is calculated. Thereafter, the same operation is performed with respect to the four points of n1, n2, n3, and n4. The same calculation is made successively with the number of the measurement point being increased. Further, the concentration value is found at the time at which the Poisson R value becomes smaller than 0.95. The concentration value smaller by 1 mol % than the thus found concentration value is taken as the maximum doping concentration Ne. Poisson R value:

R=(NΣxᵢyᵢ−ΣxᵢΣyᵢ)/(NΣ(xᵢ)²)−(Σxᵢ)²))^{1/2}(NΣ(yᵢ)²−(Σyᵢ)²)^{1/2}

The present invention still further provides a first process for producing a luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,

the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,

the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw takes an approximately predetermined value regardless of the doping concentration of the luminescent rare earth element,

the process comprising the step of: setting the doping concentration of the luminescent rare earth element in the luminescent inorganic compound at a value falling within the range of the doping concentration of the luminescent rare earth element, in which range the light absorption intensity ratio Pf/Pw takes an approximately predetermined value regardless of the doping concentration of the luminescent rare earth element.

The present invention also provides a second process for producing a luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,

the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,

the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw is approximately in proportion to the doping concentration of the luminescent rare earth element,

the process comprising the step of: setting the doping concentration of the luminescent rare earth element in the luminescent inorganic compound at a value falling within the range of 0.5 Ne mol % to 2.0 Ne mol %, wherein Ne mol % represents the highest doping concentration of the luminescent rare earth element in the range of the doping concentration of the luminescent rare earth element, in which range the light absorption intensity ratio Pf/Pw is approximately in proportion to the doping concentration of the luminescent rare earth element.

In each of the first and second luminescent inorganic compounds in accordance with the present invention and in each of the first and second processes for producing a luminescent inorganic compound in accordance with the present invention, the luminescent rare earth element may be of an arbitrary kind and may be Eu, Tb, or the like. Also, the crystal structure of each of the first and second luminescent inorganic compounds in accordance with the present invention may be a single crystal structure. Alternatively, the crystal structure of each of the first and second luminescent inorganic compounds in accordance with the present invention may have a polycrystal structure.

Each of the first and second luminescent inorganic compounds in accordance with the present invention and each of the first and second processes for producing a luminescent inorganic compound in accordance with the present invention furnishes the novel idea of the material designing of the luminescent inorganic compound containing an arbitrary luminescent rare earth element. In cases where the doping concentration of the luminescent rare earth element is set in accordance with the novel idea of the material designing, it is possible to furnish the luminescent inorganic compound having good luminescence characteristics.

“Luminescent Composition in Accordance with the Present Invention”

The luminescent composition in accordance with the present invention is characterized by containing the Eu-containing inorganic compound in accordance with the present invention or the luminescent inorganic compound in accordance with the present invention.

When necessary, the luminescent composition in accordance with the present invention may also contain an arbitrary constituent (e.g., a resin) other than the compound in accordance with the present invention.

### “Luminescent Body”

The luminescent body in accordance with the present invention is characterized by containing the Eu-containing inorganic compound in accordance with the present invention or the luminescent inorganic compound in accordance with the present invention, the luminescent body taking on the form of the molded body having been formed into a predetermined shape.

The luminescent body in accordance with the present invention is capable of being utilized as the solid laser medium, and the like.

The luminescent body in accordance with the present invention may be modified such that the molded body is a polycrystal sintered body, which is obtained from sintering processing performed on a particle molded body, the particle molded body having been obtained from processing, in which at least one kind of particles (sintering particles) containing constituents of the Eu-containing inorganic compound or the luminescent inorganic compound in accordance with the present invention are molded into a predetermined shape. As the luminescent body in accordance with the present invention, in cases where the process, or the like, is devised appropriately, it is possible to produce a polycrystal sintered body (a transparent ceramic material), which has good transparency characteristics and is capable of being utilized as the solid laser medium, and the like.

When necessary, the polycrystal sintered body described above may be subjected to, for example, processing, such as cutting, for forming into a desired shape (a prismatic shape, or the like), or end face polishing (laser grade optical polishing, or the like), and may then be utilized as the solid laser medium.

By way of example, the polycrystal sintered body may be produced with a process, wherein sintering particles containing the constituents of the compound in accordance with the present invention are prepared with the ordinary solid phase reaction ceramics technique, wherein a particle molded body is obtained from compression molding of the sintering particles, or the like, and wherein the particle molded body is sintered. (As for process examples, reference may be made to Example 1 and Example 2, which will be described later). In cases where a sintering auxiliary, such as SiO₂, is utilized when necessary, and vacuum sintering is performed, it is possible to produce the polycrystal sintered body (the transparent ceramic material), which has good transparency characteristics. In cases where the transparency characteristics are taken into consideration, the quantity of the sintering auxiliary used should preferably be as small as possible.

The sintering particles may be prepared with a technique other than the ordinary solid phase reaction ceramics technique. For example, the sintering particles containing the constituents of the compound in accordance with the present invention may be prepared with one of other techniques, such as a hydrothermal synthesis technique and an alkoxide emulsion technique.

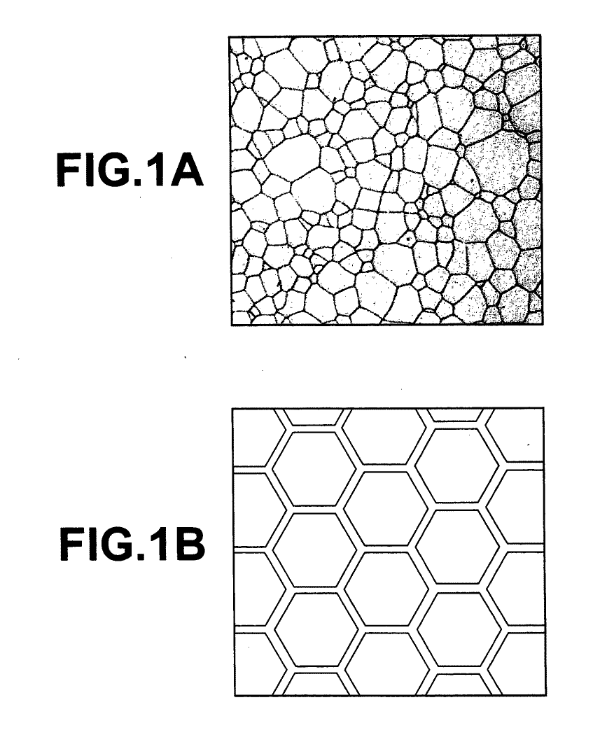

The sintering particles, which are obtained with the ordinary solid phase reaction ceramics technique, have non-uniform (random) particle sizes and non-uniform (random) particle shapes. FIG. 1A is a diagram showing a scanning type electron microscope (SEM) photograph of a cross-section of an example of a polycrystal sintered body, which is obtained from the sintering of the sintering particles obtained with the ordinary solid phase reaction ceramics technique described above. As illustrated in FIG. 1A, the crystal particles have non-uniform (random) particle sizes and shapes.

With the hydrothermal synthesis technique, the alkoxide emulsion technique, or the like, it is possible to prepare the sintering particles having approximately identical particle sizes and approximately identical particle shapes. In cases where the sintering is performed by use of the sintering particles having the approximately identical particle sizes and the approximately identical particle shapes, it is possible to produce the polycrystal sintered body, which is constituted of an aggregate of a plurality of crystal particles having the approximately identical particle sizes and the approximately identical particle shapes. In such cases, since the uniformity of the sizes of the crystal particles and the uniformity of the shapes of the crystal particles are high, a polycrystal sintered body (a transparent ceramic material) having uniform quality and good transparency characteristics is capable of being obtained.

With the alkoxide emulsion technique, it is possible to prepare, for example, the sintering particles having approximately identical particle sizes and approximately spherical particle shapes (particle diameter: e.g., approximately 0.2 μm to approximately 0.8 μm). (Reference may be made to Example 3, which will be described later.)

With the hydrothermal synthesis technique, it is possible to prepare the sintering particles having approximately identical particle sizes and approximately identical particle shapes, the particle shapes being polyhedral shapes such that the particles alone are capable of filling a space approximately closely (particle diameter: e.g., several microns to approximately 20 μm). (Reference may be made to Example 4, which will be described later.) In cases where the sintering is performed by use of the sintering particles having the approximately identical particle sizes and the approximately identical particle shapes described above, each of the sintering particles constitutes the crystal particle, and it is possible to produce the polycrystal sintered body, which is constituted of an aggregate of a plurality of crystal particles having the approximately identical particle sizes and the approximately identical particle shapes, the particle shapes being the polyhedral shapes such that the particles alone are capable of filling a space approximately closely. With the hydrothermal synthesis technique, it is possible to obtain a polycrystal sintered body (a transparent ceramic material), in which the proportion of particle boundaries is low, and which has uniform quality, a high space filling rate, and good transparency characteristics.

The term “crystal particles having approximately identical particle sizes” as used herein means that the particle diameters of the plurality of the crystal particles fall within the range of the mean particle diameter ±5%. The term “mean particle diameter” as used herein means the arithmetic mean value of the diameters (circle/sphere converted) of the crystal particles.

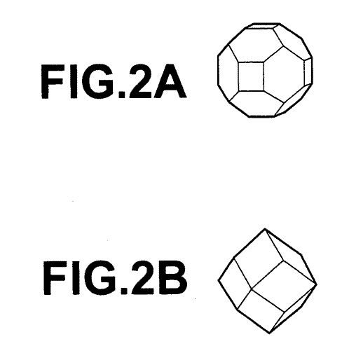

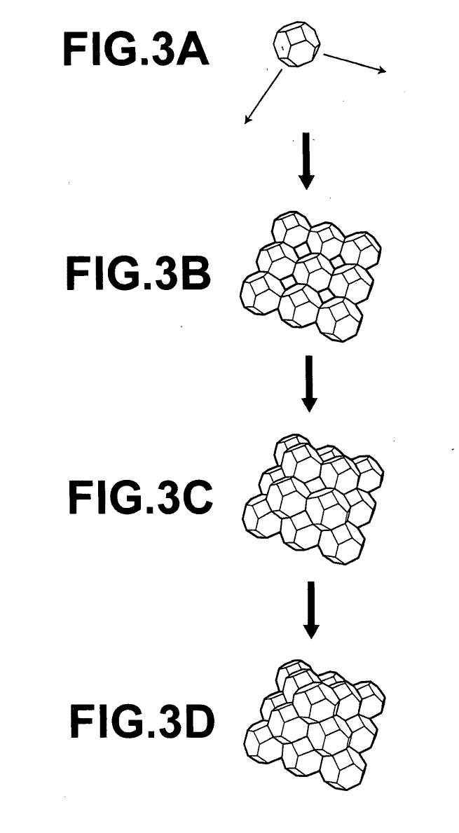

Examples of the polyhedral shapes, which polyhedral shapes alone are capable of filling a space approximately closely, include a cubic shape, a truncated octahedral shape as illustrated in FIG. 2A, and a rhombic dodecahedral shape as illustrated in FIG. 2B. FIGS. 3A, 3B, 3C, and 3D are explanatory views showing how particles having a truncated octahedral shape fill a space. FIGS. 3A, 3B, 3C, and 3D illustrate that the aforesaid particles alone are capable of filling a space approximately closely.

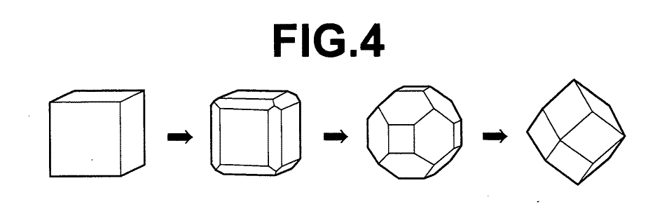

In cases where the garnet type compound is prepared with the hydrothermal synthesis technique, the shapes of the obtained particles vary in accordance with reaction conditions, such as the reaction time. As illustrated in FIGS. 4A, 4B, 4C, and 4D, incases where the conditions other than the reaction time are kept the same, the shape of each of the obtained particles alters successively with the passage of time in the order of from the cubic shape, the truncated octahedral shape, to the rhombic dodecahedral shape.

In cases where the garnet type compound is prepared with the hydrothermal synthesis technique, the particles having the truncated octahedral shapes or the rhombic dodecahedral shapes are apt to be obtained. Therefore, in cases where the sintering particles are prepared with the hydrothermal synthesis technique, and the sintering is performed by use of the thus obtained sintering particles, it is possible to obtain comparatively easily the polycrystal sintered body, which is constituted of an aggregate of a plurality of crystal particles having the approximately identical particle sizes and the approximately identical particle shapes, the particle shapes being the truncated octahedral shapes or the rhombic dodecahedral shapes.

FIG. 1B is an image view showing a cross-section of a different example of a polycrystal sintered body, in which the shapes of the crystal particles are the truncated octahedral shapes, and in which the crystal particles have uniform particle sizes and uniform particle shapes. As an aid in facilitating the comparison with the random structure illustrated in FIG. 1A, the cross-section of the polycrystal sintered body is illustrated as a typical view in FIG. 1B. Actually, as illustrated in FIG. 3D, the polycrystal sintered body has the structure, in which the crystal particles having the truncated octahedral shapes combine in three-dimensional directions. Therefore, it does not occur that the crystal particles having the truncated octahedral shapes stand side by side regularly in one cross-section. Also, in FIG. 1B, the reduction scale is different from the reduction scale in FIG. 1A. Further, in FIG. 1B, the particle boundaries are illustrated with the enlarged sizes. However, the sizes of the particle boundaries are identical with the sizes of the particle boundaries illustrated in FIG. 1A.

Besides the form of the polycrystal sintered body, the luminescent body in accordance with the present invention may take on the form of the molded body having been obtained from the processing, wherein the particles of the compound in accordance with the present invention (e.g., the particles of the polycrystal sintered body, which particles have been obtained from grinding processing) are dispersed in a solid medium, such as a light transmissive resin binder, e.g. a (meth)acrylic resin binder, or glass.

### “Solid Laser Device”

The solid laser device in accordance with the present invention comprises:

i) the solid laser medium constituted of the luminescent body in accordance with the present invention, which luminescent body is capable of producing the laser beam by being excited by the exciting light, and

ii) the exciting light source for producing the exciting light to be irradiated to the solid laser medium.

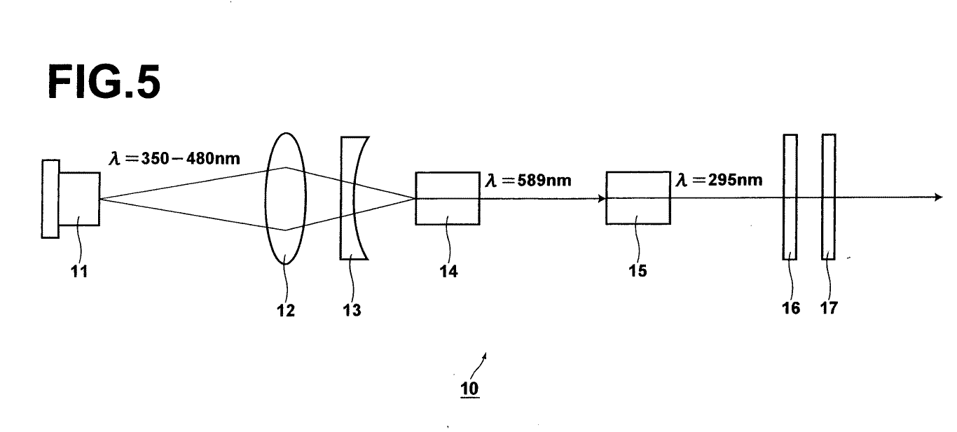

An embodiment of the solid laser device in accordance with the present invention will be described hereinbelow with reference to FIG. 5. By way of example, the embodiment of the solid laser device in accordance with the present invention is constituted as an end face pumped type of solid laser device.

A solid laser device 10, which is the embodiment of the solid laser device in accordance with the present invention, is constituted as a laser diode pumped solid laser device. The laser diode pumped solid laser device comprises a solid laser medium 14 constituted of the luminescent body in accordance with the present invention, which luminescent body is capable of producing the laser beam by being excited by the exciting light (in this case, pumping light). The solid laser device 10 also comprises a semiconductor laser diode 11 acting as an exciting light source (in this case, a pumping light source) for producing the exciting light (in this case, the pumping light) to be irradiated to the solid laser medium 14.

Also, a converging lens 12 is located between the semiconductor laser diode 11 and the solid laser medium 14. Further, an output mirror 17, which selectively transmits output light, is located at the stage after the solid laser medium 14. The solid laser medium 14 is located between a pair of resonator mirrors 13 and 16. Furthermore, a wavelength converting element 15, which may be constituted of a nonlinear optical crystal body, or the like, is located between the pair of the resonator mirrors 13 and 16.

In this embodiment, the solid laser medium 14 is constituted of the Eu:YAG polycrystal sintered body (as described later in Example 1, 2, 3, 4, or 5) in accordance with the present invention, in which the Eu doping concentration falls within the range of more than 0.5 mol % to 50.0 mol %, inclusive, preferably within the range of 5.0 mol % to 30.0 mol %, and which has good transparency characteristics. When necessary, the solid laser medium 14 may be subjected to, for example, processing, such as cutting, for forming into a desired shape, or end face polishing (laser grade optical polishing, or the like), and may then be utilized as the solid laser medium.

No limitation is imposed upon the shape of the solid laser medium 14. By way of example, the solid laser medium 14 may have a cylindrical rod-like shape, a prismatic rod-like shape, a disk-like shape, or a rectangular plate-like shape.

Eu:YAG is capable of being excited by light having a wavelength falling within the range of 300 nm to 500 nm and is capable of producing the fluorescence having a wavelength falling within the visible light wavelength range (400 nm to 700 nm). Therefore, the exciting light source may be selected in accordance with the desired wavelength of the produced fluorescence.

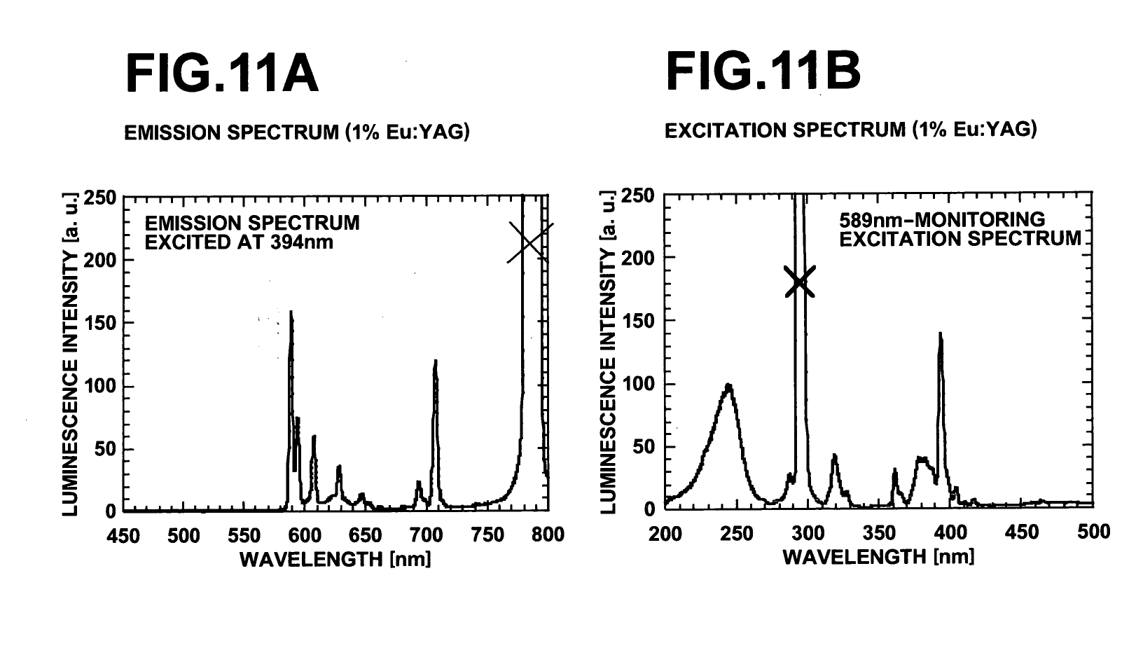

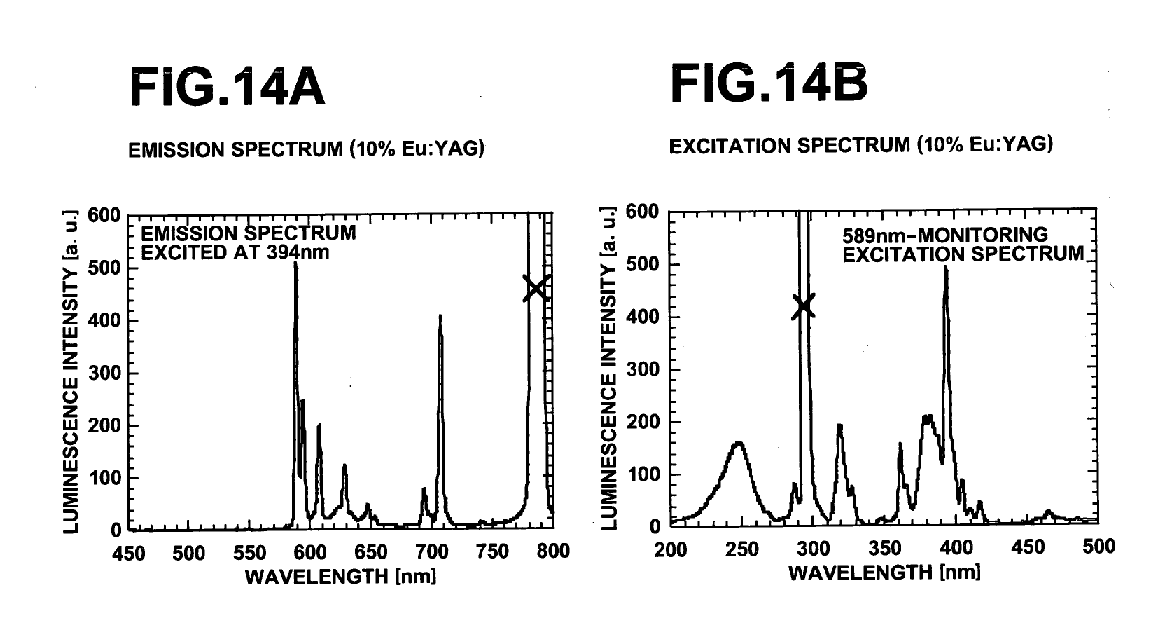

By way of example, the excitation peak wavelength for Eu:YAG is 394 nm (as illustrated in FIG. 11 or FIG. 14 for Example 1). Therefore, in such cases, the semiconductor laser diode 11 acting as the exciting light source should preferably be constituted of a semiconductor laser diode, which exhibits an oscillation peak wavelength falling within the range of 350 nm to 480 nm, or the like.

Specifically, as an example of the semiconductor laser diode, which exhibits the oscillation peak wavelength falling within the range of 350 nm to 480 nm, there may be mentioned a GaN type of semiconductor laser diode provided with an active layer, which contains at least one kind of nitrogen-containing semiconductor compound, such as GaN, AlGaN, InGaN, InAlGaN, InGaNAs, or GaNAs. The active layer of the GaN type of semiconductor laser diode should preferably be constituted of a multiple quantum well layer, such as AlN/AlGaN, AlGaN/GaN, InGaN/InGaN, InAlGaN/InAlGaN; or a quantum dot layer, such as AlGaN, GaN, or InGaN.

Examples of the semiconductor laser diodes having the oscillation peak wavelength within the range of 350 nm to 480 nm include Groups II to VI compound types of semiconductor laser diodes, such as ZnO types of semiconductor laser diodes or ZnSe types of semiconductor laser diodes.

By way of example, the solid laser medium 14 is excited by the light having a wavelength of 394 nm and produces the light having a wavelength of 589 nm falling within the visible light wavelength region.

As the wavelength converting element 15, an SHG crystal, such as a BBO crystal or a BIBO crystal, may be utilized. The light having a wavelength of 589 nm, which light has been radiated out from the solid laser medium 14, is wavelength-converted by the wavelength converting element 15 into light having a short wavelength (e.g., 295 nm) falling within the ultraviolet light region of 240 nm to 350 nm. The wavelength converting element 15 may be located within the resonator structure constituted of the pair of the resonator mirrors 13 and 16. Alternatively, the wavelength converting element 15 may be located at a position outward from the resonator structure constituted of the pair of the resonator mirrors 13 and 16.

This embodiment of the solid laser device 10 is constituted in the manner described above.

This embodiment of the solid laser device 10 is provided with the solid laser medium 14 constituted of the luminescent body containing the compound in accordance with the present invention, which compound is capable of producing the laser beam by being excited by the exciting light. Therefore, the solid laser device 10 has good luminescence characteristics and is capable of outputting a laser beam having a high luminance.

With a conventional solid laser device, for example, a solid laser medium constituted of Nd:YAG or Nd:YVO₄ is excited by a GaAs type of semiconductor laser having an oscillation peak wavelength of 808 nm to produce a laser beam having a wavelength of 1,064 nm. The thus produced laser beam is wavelength-converted by a first wavelength converting element into light having a wavelength of 532 nm. The thus obtained light having a wavelength of 532 nm is further wavelength-converted by a second wavelength converting element into light having a wavelength of 355 nm or 266 nm. Ultraviolet light is thus obtained through the two stages of the wavelength conversion.

With this embodiment of the solid laser device 10, the ultraviolet light is capable of being obtained with only one time of wavelength conversion. Therefore, the device constitution of the solid laser device 10 in accordance with the present invention is capable of being kept simpler than the device constitution of the conventional solid laser device. Also, it is possible to obtain an ultraviolet light outputting solid laser device, which has a high light utilization efficiency.

This embodiment of the solid laser device 10 may be modified such that the wavelength converting element 15 is not provided, and such that the light having a wavelength of 589 m falling within the visible light wavelength region, which light has been produced by the solid laser medium 14, is outputted from the solid laser device.

Eu:YAG has a plurality of oscillation peak wavelengths. Therefore, the wavelength of the laser beam produced by the solid laser medium 14 and the wavelength of the output light radiated out from the solid laser device 10 are capable of being set at wavelengths different from the wavelengths described above.

### (Examples of Design Modification)

The solid laser device in accordance with the present invention is not limited to the embodiment described above, and the device constitution may be modified in various ways.

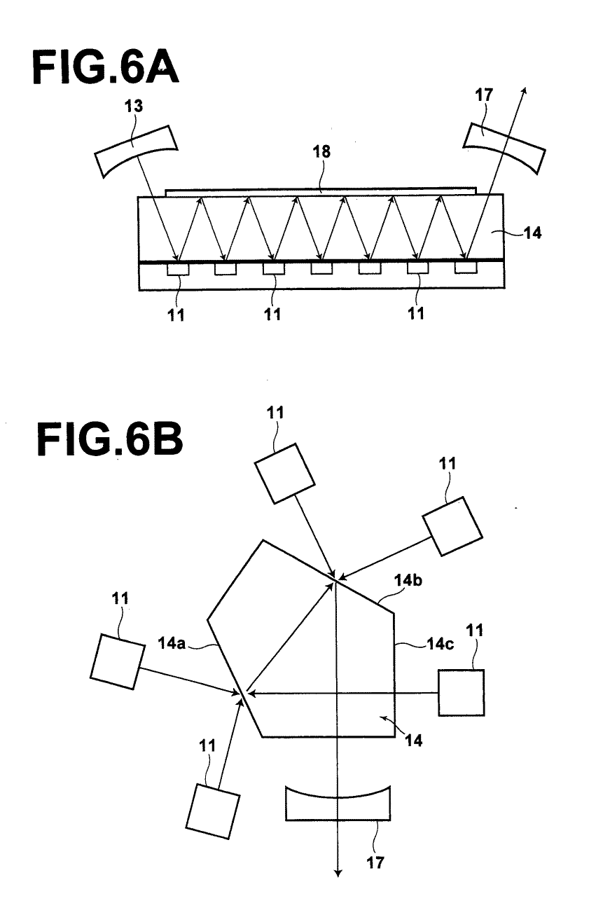

For example, as illustrated in FIG. 6A, a surface emission laser array, which is constituted of an array of a plurality of semiconductor laser diodes 11, 11, . . . , may be fitted to one surface of the solid laser medium 14, and a reflecting mirror 18 may be located on the opposite surface of the solid laser medium 14. Also, the reflecting mirror 13 may be located at a position corresponding to one side end of the solid laser medium 14, and the output mirror 17 may be located at a position corresponding to the opposite side end of the solid laser medium 14, such that the reflecting mirror 13 and the output mirror 17 may be approximately symmetric with each other. In this manner, a zigzag path slab solid laser device may be constituted. With the modification described above, a resonator structure is constituted among the reflecting mirror 13, the exciting light incidence surface of the solid laser medium 14, the reflecting mirror 18, and the output mirror 17.

In lieu of the surface emission laser array, which is constituted of the array of the plurality of the semiconductor laser diodes 11, 11, . . . , the exciting light source may be constituted of an array of end sections of a plurality of fiber lasers.

Alternatively, as illustrated in FIG. 6B, the solid laser medium 14 may be constituted of a polyhedral prism obtained from, for example, cutting and polishing processing performed on a polycrystal sintered body of Eu:YAG having good transparency characteristics (as will be described later in Example 1, 2, 3, 4, or 5). Also, the output mirror 17 may be located so as to stand facing one surface of the solid laser medium 14, and a plurality of semiconductor laser diodes 11, 11, . . . may be located so as to stand facing the other surfaces of the solid laser medium 14. In this manner, a laser diode pumped polyhedral prism type solid laser device may be constituted. In the modification described above, each of exciting light incidence surfaces 14a, 14b, and 14c of the solid laser medium 14 is provided with a coating layer, which transmits the light having the wavelengths falling within the excitation wavelength range, and which reflects the light having the output wavelengths. With the constitution described above, the solid laser medium 14 itself constitutes the resonator structure. In lieu of the plurality of the semiconductor laser diodes 11, 11, . . . , the exciting light source may be constituted of a plurality of fiber lasers.

With each of the modifications of the solid laser device illustrated in FIG. 6A and FIG. 6B, the single solid laser medium 14 is capable of being pumped by the plurality of the semiconductor laser diodes 11, 11, . . . . . Therefore, a solid laser device having a high output is capable of being obtained. In each of the modifications of the solid laser device illustrated in FIG. 6A and FIG. 6B, though a wavelength converting element is not provided, it is possible to locate the wavelength converting element, when necessary.

### “Light Emitting Device”

The light emitting device in accordance with the present invention comprises:

i) the luminescent body in accordance with the present invention, and

ii) the exciting light source for producing the exciting light to be irradiated to the luminescent body.

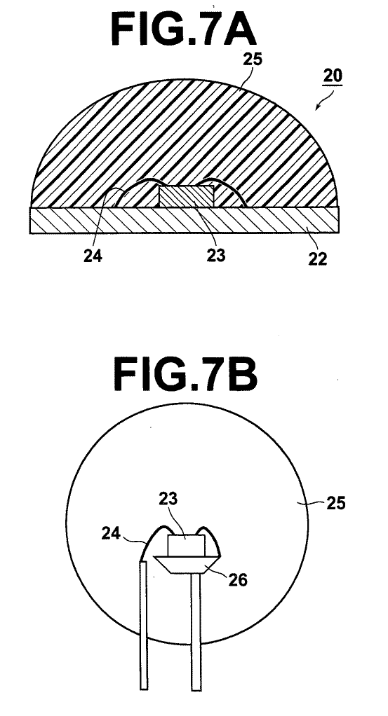

An embodiment of the light emitting device in accordance with the present invention will be described hereinbelow with reference to FIG. 7A. FIG. 7A is a sectional view showing an embodiment of the light emitting device in accordance with the present invention, the view being taken in a thickness direction of a circuit base plate 22.

A light emitting device 20, which is an embodiment of the light emitting device in accordance with the present invention, comprises the circuit base plate 22 having a circular disk-like shape. The light emitting device 20 in accordance with the present invention also comprises a light emitting element 23 acting as the exciting light source. The light emitting element 23 is located at the middle of the surface of the circuit base plate 22. The light emitting device 20 in accordance with the present invention further comprises a dome-shaped luminescent body 25, which has been molded on the circuit base plate 22 so as to surround the light emitting element 23.

The light emitting element 23 for producing the exciting light to be utilized for exciting the luminescent body 25 is constituted of a semiconductor light emitting diode, or the like. The light emitting element 23 is electrically connected to the circuit base plate 22 by a bonding wire 24.

In this embodiment, the luminescent body 25 is constituted of the molded body having been obtained from the processing, wherein the particles of the Eu:YAG polycrystal sintered body (as described later in Example 1, 2, 3, 4, or 5) in accordance with the present invention, in which the Eu doping concentration falls within the range of more than 0.5 mol % to 50.0 mol %, inclusive, preferably within the range of 5.0 mol % to 30.0 mol %, and which has good transparency characteristics, the particles having been obtained from the grinding processing, are dispersed in a light transmissive resin binder, such as a (meth) acrylic resin binder, and are molded.

In this embodiment, the luminescent body 25 is prepared in the manner described below. Specifically, a polycrystal sintered body of Eu:YAG in accordance with the present invention is subjected to the grinding processing in a mortar, and the particles of the aforesaid polycrystal sintered body are thereby obtained. Thereafter, the particles having been obtained from the grinding processing are subjected to kneading processing together with a light transmissive resin, such as a (meth) acrylic resin, in a resin melt state. From the kneading processing, a mixture of the particles of the polycrystal sintered body of Eu:YAG and the light transmissive resin (e.g., Eu:YAG/PMMA resin=3:4 (mass ratio)) is obtained. The circuit base plate 22, on which the light emitting element 23 has been located, is then located in a mold, and the aforesaid mixture is subjected to injection molding and molded on the circuit base plate 22.

Eu:YAG is capable of being excited by light having a wavelength falling within the range of 350 nm to 480 nm and is capable of producing the luminescence having a wavelength falling within the visible light wavelength range (400 nm to 700 nm). Therefore, the exciting light source may be selected in accordance with the desired wavelength of the produced luminescence.

The light emitting element 23 acting as the exciting light source should preferably be constituted of, for example, a GaN type of semiconductor light emitting diode (oscillation peak wavelength: 360 nm to 500 nm) provided with an active layer, which contains at least one kind of nitrogen-containing semiconductor compound, such as GaN, AlGaN, InGaN, InAlGaN, InGaNAs, or GaNAs; a ZnSSe type of semiconductor light emitting diode (oscillation peak wavelength: 450 nm to 520 nm); or a ZnO type of semiconductor light emitting diode (oscillation peak wavelength: 360 nm to 450 nm).

In this embodiment, the luminescent body 25 produces the luminescence of a color tone different from the color tone of the light radiated out from the light emitting element 23. As a result, light, which is of the mixed color of the light radiated out from the light emitting element 23 and the luminescence produced by the luminescent body 25, is radiated out from the light emitting device 20.

This embodiment of the light emitting device 20 utilizes the luminescent body 25 containing the compound in accordance with the present invention. Therefore, this embodiment of the light emitting device 20 exhibits good luminescence characteristics and is capable of producing light having a high luminance. This embodiment of the light emitting device 20 is capable of being utilized appropriately as a white light emitting diode, or the like.

The light emitting device in accordance with the present invention is not limited to the embodiment described above, and the device constitution may be modified in various ways. For example, as illustrated in FIG. 7B, a luminescent body 25 may be molded into a circular disk-like shape, and a mounting block 26 may be located so as to protrude from the surface of the luminescent body 25. Also, the light emitting element 23 acting as the exciting light source may be located on the mounting block 26. FIG. 7B is a plan view showing an example of design modification of the light emitting device in accordance with the present invention, the view being taken from the side of the light emitting element 23. With the constitution illustrated in FIG. 7B, the light emitting device is capable of being constituted without the circuit base plate 22 being utilized. Therefore, light is capable of being obtained from opposite sides of the luminescent body 25 (i.e., from both the side of the light emitting element 23 and the opposite side), i.e. from every direction.

Besides the solid laser device and the light emitting device described above, the compound in accordance with the present invention, the composition in accordance with the present invention, and the luminescent body in accordance with the present invention are capable of being utilized in a wide variety of other use applications.

### EXAMPLES

The present invention will further be illustrated by the following nonlimitative examples.

### Example 1

Polycrystal sintered bodies of Eu:YAG, in which Eu was doped into YAG (Y₃Al₅O₁₂) acting as the matrix compound, were prepared in the manner described below. A total of 12 kinds of samples described below, in which the Eu doping concentration was set at various different values, were prepared. (The proportion in units of % represents the Eu doping concentration expressed in terms of mol %.)
Sample 1: 0.0% Eu:YAG
Sample 2: 1.0% Eu:YAG
Sample 3: 2.0% Eu:YAG
Sample 4: 3.0% Eu:YAG
Sample 5: 4.0% Eu:YAG
Sample 6: 5.0% Eu:YAG
Sample 7: 7.0% Eu:YAG
Sample 8: 10.0% Eu:YAG
Sample 9: 15.0% Eu:YAG
Sample 10: 20.0% Eu:YAG
Sample 11: 30.0% Eu:YAG
Sample 12: 50.0% Eu:YAG

Firstly, Y₂O₃ particles (purity: 99.9%), α-Al₂O₃ particles (purity: 99.99%), and Eu₂O₃ particles (purity: 99.99%) were weighed out in quantities such that desired compositions might be obtained.

For example, as for 1.0% Eu:YAG (the sample 2, Y/Eu molar ratio=2.97/0.03), the raw material particle composition was constituted of 33.533 g of Y₂O₃ particles, 25.490 g of α-Al₂O₃ particles, and 0.528 g of Eu₂O₃ particles.

The raw material particles described above, 100 ml of ethyl alcohol, and 150 10 mm-diameter alumina balls were put into a pot mill and were subjected to wet mixing processing for 12 hours.

Thereafter, the alumina balls were removed, and ethyl alcohol was removed from the resulting mixed particle slurry by use of a rotary evaporator. The mixed particles were then dried at a temperature of 100° C. for 12 hours. The resulting dry particles were slightly unfastened in a mortar. The thus obtained dry particles were subjected to uniaxial compression molding processing at a molding pressure of 100 MPa and thus molded into a pellet (a circular cylinder-shaped pellet) having a diameter of 10 mm and a height of 5 mm.

The compression molded body having thus been obtained was subjected to a preliminary firing process in an electric furnace under an air atmosphere. Specifically, with the preliminary firing process, the temperature of the compression molded body was raised to 1,450° C. at a temperature rise rate of 500° C./hr and was kept at 1,450° C. for two hours, and the compression molded body was then cooled to a temperature of 1,000° C. at a temperature fall rate of 500° C./hr and was then subjected to natural furnace cooling.

After the preliminarily sintered body had cooled to normal temperatures, the preliminarily sintered body was subjected to grinding processing in a mortar. In the manner described above, the sintering dry particles containing the constituents for Eu:YAG were obtained with the ordinary solid phase reaction ceramics technique. The sintering dry particles had non-uniform (random) particle sizes and non-uniform (random) particle shapes.

The sintering dry particles having thus been obtained were again subjected to the uniaxial compression molding processing at a molding pressure of 100 MPa and thus molded into a pellet (a circular cylinder-shaped pellet) having a diameter of 10 mm and a height of 5 mm.

The compression molded body (the particle molded body) having thus been obtained was subjected to a final firing process in the electric furnace under an air atmosphere. Specifically, with the final firing process, the temperature of the recompression molded body was raised to 1,700° C. at a temperature rise rate of 500° C./hr and was kept at 1,700° C. for two hours, and the recompression molded body was then cooled to a temperature of 1,000° C. at a temperature fall rate of 500° C./hr and was then subjected to natural furnace cooling. In this manner, the polycrystal sintered body of Eu:YAG, in which the Eu doping concentration had been set at the desired value, was obtained.

### <Powder X-Ray Diffraction (XRD) Measurement>

Each of the samples 1 to 12 was subjected to grinding processing in a mortar and then subjected to powder X-ray diffraction (XRD) measurement with an X-ray diffraction apparatus (supplied by Rigaku Co.). Measurement conditions were set at CuKα, 40 kV, 40 mA, scanning speed: 0.5 deg/min, light receiving slit: 0.15 mm. As for the principal samples, the XRD measurement results as illustrated in FIG. 8 were obtained. As for every sample, it was confirmed that the diffraction peak perfectly coincided with the diffraction peak of JCPDS#33-0040 (YAG cubic crystal), and that the sample had the single phase structure. It was thus revealed that, in each of the cases of the samples 2 to 12, which had been doped with Eu, all of Eu, which had been loaded, entered into YAG of the matrix compound, and Y at the A site was appropriately substituted by Eu through the formation of the solid solution.

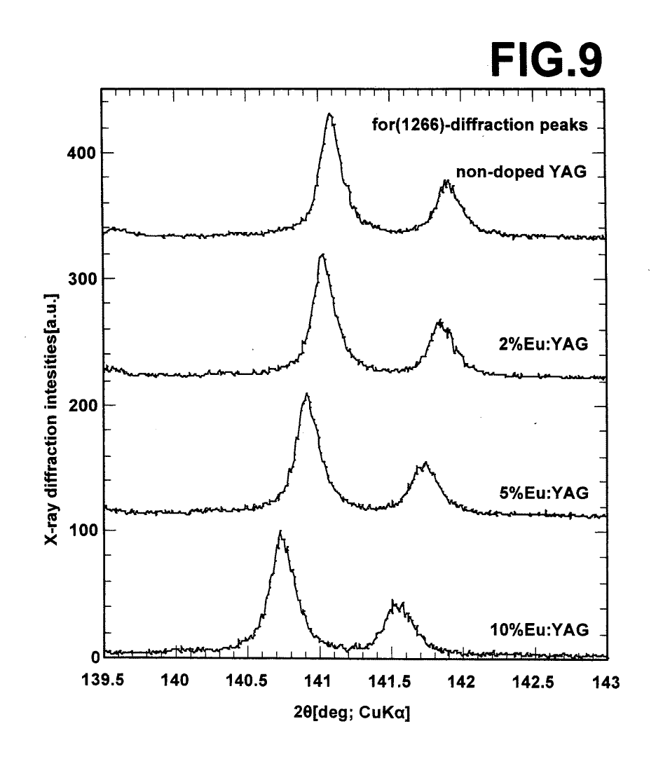

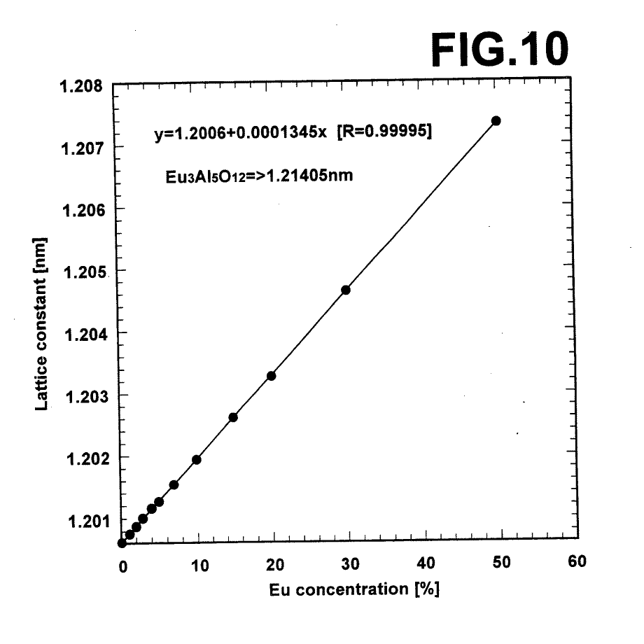

FIG. 9 is an enlarged graph showing the XRD behavior of each of the principal samples in the high angle region. As illustrated in FIG. 9, in accordance with an increase in Eu doping concentration, the diffraction peak shifts to the low angle side, and the lattice expands.

### <Lattice Constant>

The inventors calculated the lattice constant in accordance with the results of the XRD measurement described above. Specifically, a diffraction peak value of the YAG cubic crystal at 20=100° to 150° was obtained by use of the tangential method, and an accurate lattice constant was calculated by use of the Nelson-Riley function. From the calculations, the lattice constants as illustrated in FIG. 10 were obtained.

The Nelson-Riley function may be represented by the formula ½ (cosθ)²(1/sinθ+1/θ). The obtained value is plotted on the x axis. Also, the lattice constant a having been obtained from the Bragg diffraction conditions is plotted on the y axis. The value of the y-intercept of the straight line of the method of least squares is taken as the true lattice constant.

FIG. 10 shows that, over the entire range of the Eu doping concentration of 0 to 50 mol %, the lattice constant increases linearly in accordance with an increase in Eu doping concentration. Specifically, it is indicated that, over the entire range of the Eu doping concentration of 0 to 50 mol %, the substitution through the formation of the solid solution was performed in accordance with the Vegard's law. It is also indicated that all of Eu, which had been loaded, entered into YAG of the matrix compound, and Y at the A site was appropriately substituted by Eu through the formation of the solid solution.

As the correlation formula between the Eu concentration x (in units of mol %) at the A site and the lattice constant y, the formula shown below was obtained.

y=1.2006+0.0001345x

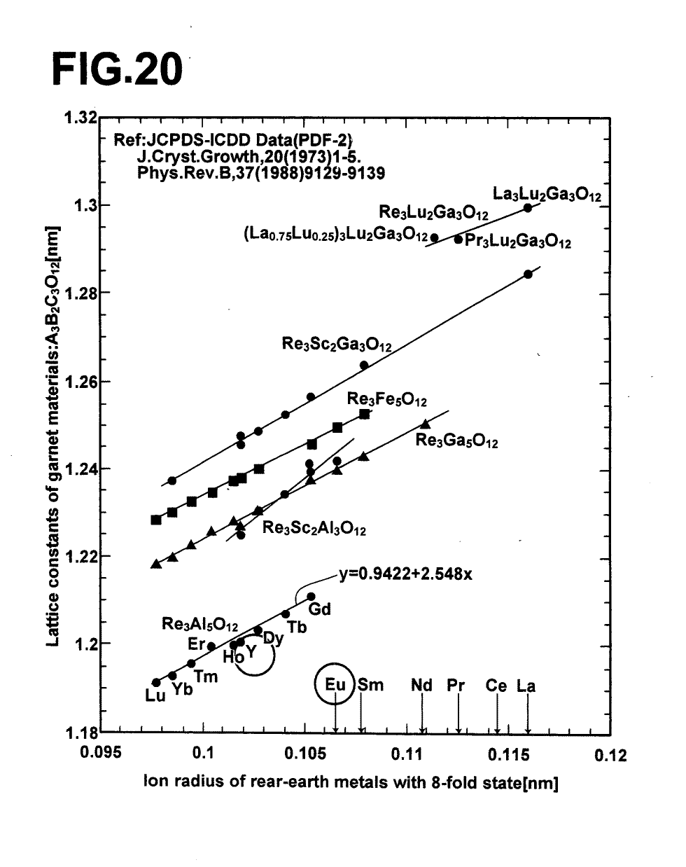

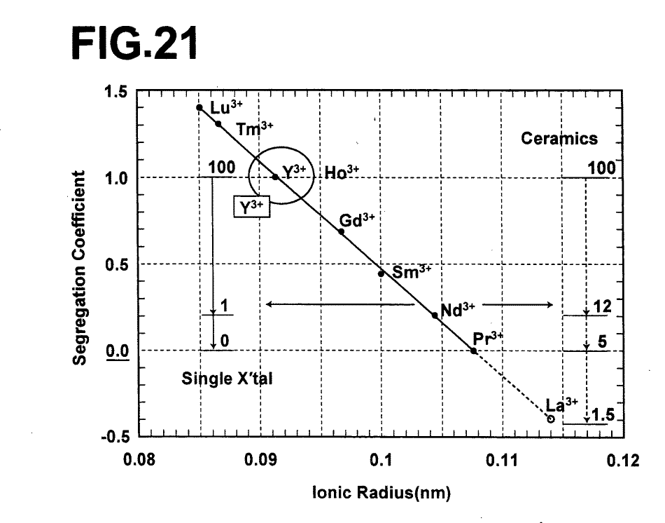

The inventors have found that, as illustrated in FIG. 20, the correlation between the ionic radius x and the lattice constant y of the rare earth element in the rare earth element aluminum garnet type compound (RE₃Al₅O₁₂) may be represented by the formula:

Lattice constant y=0.9422+2.548x

(where each of x and y is in units of [nm])

In cases where the ionic radius (=0.1066 nm) of the Eu³⁺ ions (at the A site) is substituted into the formula shown above, and the imaginary lattice constant of the garnet type compound Eu₃Al₅O₁₂ is estimated, the lattice constant is estimated as being 1.21382 nm. The estimated lattice constant is markedly close to the value of the lattice constant (=1.21405 nm), which is calculated in cases where the Eu doping concentration is set at 100 mol % (perfect substitution of Y by Eu) in FIG. 10. It is thus found that the evaluation in FIG. 10 is appropriate.

The term “ionic radius” as used herein means the so-called “Shannon's ionic radius.” (As for the Shannon's ionic radius, reference may be made to, for example, a literature of R. D. Shannon, Acta Crystallogr A32, 751 (1976) .)<

### <Luminescence Characteristics of 1.0% Eu:YAG>

As for 1.0% Eu:YAG (the sample 2) acting as the representative of the samples having the comparatively low doping concentrations, the sample was subjected to emission spectrum (fluorescence spectrum) measurement by use of a fluorescence spectrophotometer (F-4500, supplied by Hitachi, Ltd.).

The wavelength λₑₓ of the exciting light was set at 394 nm, which was associated with the maximum luminescence intensity when the excitation spectrum was taken with respect to the Eu-doped compound. The emission spectrum as illustrated in FIG. 11A was obtained. (In FIG. 11A, the mark “x” represents the leakage of the higher order light of the exciting light.) As illustrated in FIG. 11A, the sample described above exhibited the characteristics such that a plurality of luminescence peaks were found in the visible light wavelength range of 400 nm to 700 nm. Also, the luminescence peak of the highest intensity was found at a wavelength of 589 nm.

Thereafter, with respect to the same sample, measurement was made to find the excitation spectrum, which represents the luminescence intensity (the fluorescence intensity) at the highest luminescence peak wavelength (589 nm) within the visible light wavelength region with respect to the excitation wavelengths. From the measurement, the excitation spectrum as illustrated in FIG. 11B was obtained. (In FIG. 11A, the mark “x” represents the leakage of the higher order light of the exciting light.)

The excitation spectrum illustrated in FIG. 11B had the plurality of the excitation peak wavelengths in the wavelength region shorter than 470 nm. Of the plurality of the excitation peak wavelengths in the wavelength region shorter than 470 nm, the excitation peak wavelength, which was associated with the highest light absorption intensity and the highest luminescence intensity, was 394 nm. Also, the excitation peak wavelength, which was associated with the second highest light absorption intensity and the second highest luminescence intensity, was 240 nm of the ultraviolet light wavelength region. The excitation spectrum indicated that the luminescence having the wavelength of 589 nm was capable of being obtained with the excitation by the exciting light having the wavelength of 394 nm and the exciting light having the wavelength of 240 nm.

The wavelength of 394 nm falls within the wavelength range of the laser beam produced by the GaN type of semiconductor laser, the ZnO type of semiconductor laser, or the like. Therefore, it was thus indicated that the existing light source is capable of being used as the exciting light source for Eu:YAG.

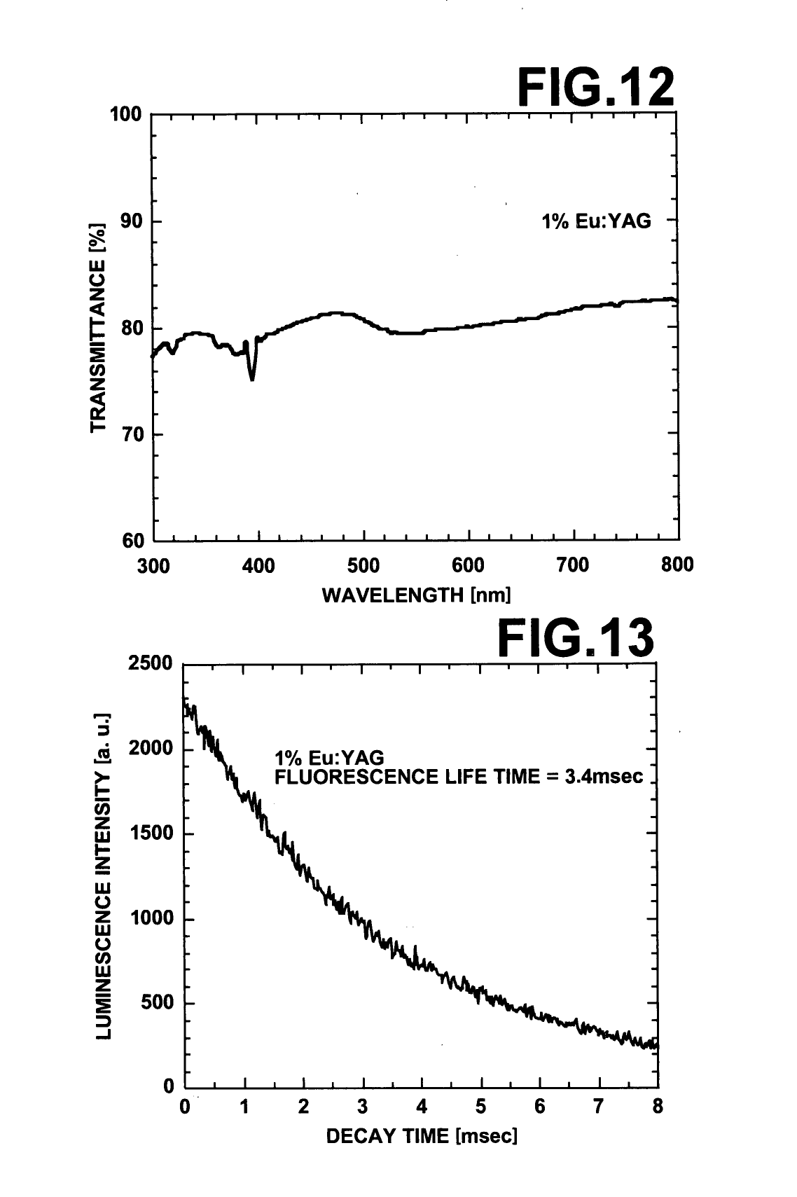

For reference, with respect to a commercially available 1.0% Eu:YAG single crystal, a transmission absorption spectrum in the visible light wavelength region was measured by use of a spectrophotometer (U-13310, supplied by Hitachi, Ltd.). From the measurement, the transmission absorption spectrum as illustrated in FIG. 12 was obtained. The obtained transmission absorption spectrum indicated strong absorption at the wavelength of 394 nm. Thus the results coinciding with the excitation spectrum described above were obtained.

Thereafter, a fluorescence life time of 1.0% Eu:YAG (the sample 2) was measured by use of a picosecond fluorescence life time measuring apparatus (C4780, supplied by Hamamatsu Photonics Co.). A nitrogen laser pumped dye laser (20 Hz) was used as the exciting light source, and the wavelength of 394 nm was selected for the excitation.

The results of the measurement of the fluorescence life time of 1.0% Eu:YAG (the sample 2) as illustrated in FIG. 13 were obtained. In cases where an inverted distribution necessary for laser oscillation is taken into consideration, it is considered that a slightly long life time is required of the solid laser medium. As illustrated in FIG. 13, the fluorescence life time of 1.0% Eu:YAG was 3.4 milliseconds. It was thus indicated that 1.0% Eu:YAG had the sufficiently long fluorescence life time required of the solid laser medium.

### <Luminescence Characteristics of 10.0% Eu:YAG>

As for 10.0% Eu:YAG (the sample 8) acting as the representative of the samples having the comparatively high doping concentrations, the sample was subjected to the emission spectrum measurement and the excitation spectrum measurement, each of which was made in the same manner as that for the sample 2. The results as illustrated in FIG. 14A and FIG. 14B were obtained.

When the emission spectrum illustrated in FIG. 11A and the emission spectrum illustrated in FIG. 14A were compared with each other, it was revealed that the luminescence intensity at the wavelength of 589 nm, which luminescence intensity was obtained at the excitation wavelength of 394 nm and with 10.0% Eu:YAG (the sample 8), was at least three times as high as the luminescence intensity at the wavelength of 589 nm, which luminescence intensity was obtained at the excitation wavelength of 394 nm and with 1.0% Eu:YAG (the sample 2).

Also, when the excitation spectrum illustrated in FIG. 11B and the excitation spectrum illustrated in FIG. 14B were compared with each other, it was revealed that the ratio of the luminescence intensity at the wavelength of 589 nm, which luminescence intensity was obtained at the excitation peak wavelength of 394 nm, to the luminescence intensity at the wavelength of 589 nm, which luminescence intensity was obtained at the excitation peak wavelength of 240 nm, varied in accordance with the Eu doping concentration. Specifically, it was revealed that, in cases where the Eu doping concentration was high, the rate of absorption at the wavelength of 394 nm became high.

### <Relationship Between Doping Concentration and Luminescence Characteristics>

With respect to the other samples, the emission spectrum measurement was made in the same manner as that for the sample 2 and the sample 8. The relationship between the Eu doping concentration and the luminescence intensity at the wavelength of 589 nm, which luminescence intensity was obtained at the excitation wavelength of 394 nm, was as illustrated in FIG. 15A.

As illustrated in FIG. 15A, it was revealed that, with Eu:YAG, the luminescent characteristics were obtained over the entire range of the Eu doping concentration of more than 0 mol % to 50.0 mol %, inclusive. Particularly, it was revealed that a high luminescence intensity was capable of being obtained with the Eu doping concentration falling within the range of 5.0 mol % to 30.0 mol %. As for the polycrystal Eu: YAG, 0.5% Eu:YAG was reported in the past. Therefore, the polycrystal Eu:YAG, in which the Eu doping concentration falls within the range of more than 0.5 mol % to 50.0 mol %, inclusive, the range having not been reported in the past, is the novel compound.

In the cases of the majority of the luminescent rare earth elements, attenuation of the luminescence (referred to as the concentration quenching) due to the high concentration doping occurs on the side of the low doping concentration side. However, in the cases of Eu:YAG, up to the high concentration, the concentration quenching did not occur. The Eu:YAG, which exhibits little concentration quenching in cases where Eu is doped at a high concentration, is useful in that, for example, in cases where Eu:YAG is used as the solid laser medium, the exciting light absorption quantity is capable of being set at a large value.

For reference, FIG. 15B shows the data (single crystal Eu:YAG) in FIG. 3 in the non-patent literature 3 mentioned above in “Background Art,” which data have been converted into the data in units of mol %, and the data (polycrystal Eu:YAG) in FIG. 15A for Example 1 in accordance with the present invention. In FIG. 15B, the luminescence intensity is represented by the relative value obtained in cases where both the peak top in the data in FIG. 3 in the non-patent literature 3 described above and the peak top in the data obtained in Example 1 in accordance with the present invention are taken as 100.

The polycrystal Eu:YAG of Example 1 in accordance with the present invention and the single crystal Eu:YAG in the non-patent literature 3 exhibited the approximately identical relationships between the Eu doping concentration and the luminescence intensity at the wavelength of 589 nm, which luminescence intensity was obtained at the excitation wavelength of 394 nm. From the results, it was revealed that, in Example 1, the polycrystal Eu:YAG, which had the characteristics identical with the characteristics of the single crystal Eu:YAG, was capable of being accomplished.

### <Relationship Between Doping Concentration and Excitation Characteristics>

With respect to the other samples, the excitation spectrum measurement was made in the same manner as that for the sample 2 and the sample 8. FIG. 16 is a graph showing the relationship between the Eu doping concentration and the light absorption intensity ratio Pf/Pw between the two excitation peak wavelengths (in Example 1, 394 nm and 240 nm), which are associated with the highest luminescence intensity and the second highest luminescence intensity among the plurality of the excitation peak wavelengths in the wavelength region shorter than 470 nm, wherein Pf represents the light absorption intensity at the excitation peak wavelength on the long wavelength side when the two excitation peak wavelengths, which are associated with the highest luminescence intensity and the second highest luminescence intensity, are compared with each other, and wherein Pw represents the light absorption intensity at the excitation peak wavelength on the short wavelength side when the two excitation peak wavelengths, which are associated with the highest luminescence intensity and the second highest luminescence intensity, are compared with each other.

As illustrated in FIG. 16, in cases where the Eu doping concentration fell within the range of at most 5.0 mol %, the light absorption intensity ratio Pf/Pw became high approximately in proportion to the increase in Eu doping concentration. Also, in cases where the Eu doping concentration fell within the range of 5.0 mol % to 20.0 mol %, the light absorption intensity ratio Pf/Pw took the approximately predetermined value regardless of the Eu doping concentration. The concentration dependency described above is the novel finding, which the inventors obtained. Though not clear perfectly, the inventors consider that there is a close relationship between the Eu concentration and the charge transfer state (CTS), and therefore the concentration dependency is exhibited.

In this example, the range of the Eu doping concentration, which range is associated with a high luminescence intensity as illustrated in FIG. 15A, corresponded to the range of the Eu doping concentration, in which range the light absorption intensity ratio Pf/Pw took the approximately predetermined value regardless of the Eu doping concentration.

Also, the range of the Eu doping concentration, which range is associated with a high luminescence intensity as illustrated in FIG. 15A, corresponded to the range of the Eu doping concentration of 0.5 Ne mol % to 2.0 Ne mol %, wherein Ne mol % represents the highest Eu doping concentration in the range of the Eu doping concentration, in which range the light absorption intensity ratio Pf/Pw was approximately in proportion to the Eu doping concentration. In this example, Ne took the value of 9 (mol %).

The inventors consider that the luminescence intensity and the light absorption intensity ratio Pf/Pw have the relationship with each other, and that the high luminescence intensity is capable of being obtained in cases where the Eu doping concentration is set at a value falling within the range of the Eu doping concentration, in which range the light absorption intensity ratio Pf/Pw takes the approximately predetermined value regardless of the Eu doping concentration, or within the range of the Eu doping concentration of 0.5 Ne mol % to 2.0 Ne mol %. Also, the inventors consider that, besides Eu:YAG, the material designing described above is also applicable to other compounds.

<Observation with Scanning Type Electron Microscope (SEM)>

Observation of a cross-section of each of the polycrystal sintered bodies of the sample 1 to sample 12 with a scanning type electron microscope (SEM) revealed that the high-density sintered body was obtained in each case and that the crystal particles had the non-uniform (random) particle sizes and the non-uniform (random) particle shapes (as illustrated in FIG. 1A).

### Example 2

A 15% Eu:YAG polycrystal sintered body (a transparent ceramic material, Y/Eu molar ratio=2.55/0.45) was prepared in the manner described below. In this example, SiO₂ acting as a sintering auxiliary was added. The raw material particles were blended such that 0.1 mol % of the Al site might be substituted by Si.

Firstly, Y₂O₃ particles (purity: 99.9%), α-Al₂O₃ particles (purity: 99.99%), Eu₂O₃ particles (purity: 99.99%), and SiO₂ particles (purity: 99.99%) were weighed out in quantities such that a desired composition might be obtained.

The wet mixing processing of the raw material particles described above, the drying of the mixed particle slurry, the compression molding processing of the dry particles, and the preliminary firing process at 1,450° C. were performed in the same manner as that in Example 1. Thereafter, the preliminarily sintered body was subjected to the grinding processing in a mortar.

Thereafter, the particles, which had been obtained from the grinding processing, and ethanol were mixed together so as to form a slurry having a high viscosity. The resulting slurry was then subjected to ball mill grinding processing for 24 hours and was then dried. In the manner described above, the sintering dry particles containing the constituents for Eu:YAG were obtained with the ordinary solid phase reaction ceramics technique. The sintering dry particles had non-uniform (random) particle sizes and non-uniform (random) particle shapes. The sintering dry particles having thus been obtained were again subjected to the uniaxial compression molding processing at a molding pressure of 100 MPa and thus molded into a pellet (a circular cylinder-shaped pellet) having a diameter of 10 mm and a height of 5 mm.

The compression molded body (the particle molded body) having thus been obtained was subjected to a preliminary firing process in an electric furnace under an air atmosphere. Specifically, with the preliminary firing process, the temperature of the compression molded body was raised to 1,450° C. at a temperature rise rate of 500° C./hr and was kept at 1,450° C. for two hours, and the compression molded body was then cooled to a temperature of 1,000° C. at a temperature fall rate of 500° C./hr and was then subjected to natural furnace cooling.

Thereafter, instead of the preliminarily sintered body being subjected to the grinding processing, the preliminarily sintered body having thus been obtained was subjected to a final firing process in an electric furnace, which was capable of performing vacuum firing, under a vacuum atmosphere (1.0×10⁻³ Pa). Specifically, with the final firing process, the temperature of the preliminarily sintered body was raised to 1,750° C. at a temperature rise rate of 500° C./hr and was kept at 1,750° C. for 15 hours, and the preliminarily sintered body was then cooled to a temperature of 1,000° C. at a temperature fall rate of 500° C./hr and was then subjected to natural furnace cooling. Further, opposite surfaces of the thus obtained finally fired body were polished. In this manner, the polycrystal sintered body of Eu:YAG (added with Si), in which the Eu doping concentration had been set at the desired value, was obtained.

The thus obtained polycrystal sintered body exhibited good transparency characteristics. It was thus confirmed that, with the process of Example 2, the transparent ceramic material having good transparency characteristics required of the solid laser medium, or the like, was capable of being obtained.

The thus obtained polycrystal sintered body was ground and subjected to the XRD measurement in the same manner as that in Example 1. It was confirmed that the diffraction peak perfectly coincided with the diffraction peak of JCPDS#33-0040 (YAG cubic crystal), and that the sample had the single phase structure.

### Example 3

A 10% Eu:YAG polycrystal sintered body (a transparent ceramic material) was prepared in the manner described below.

Firstly, sintering particles were prepared with the alkoxide emulsion technique. Specifically, as metal alkoxides acting as the raw materials, 3.59 g of Y(iso-OPr)₃ particles (purity: 99.90), 6.16 g of an Al (sec-OBu)₃ gel-like substance (purity: 99.99%), and 0.49 g of Eu (iso-OPr)₃ particles were weighed out. The metal alkoxides having been weighed out were introduced into 52.9 ml of 1-octanol. The metal alkoxides were stirred at 120° C. for 12 hours under an N₂ gas flow in a flask made from Pyrex (trade name) and were thus dissolved in 1-octanol.

After the resulting solution was cooled to the room temperature, 36.36 ml of acetonitrile and 0.02 g of hydroxypropyl cellulose (acting as a dispersing agent) were added to the solution. The resulting mixture was stirred for five minutes, and an alkoxide emulsion was thus obtained. After the temperature of the alkoxide emulsion having thus been obtained was raised to 40° C., a 1-octanol/acetonitrile/water mixed liquid (blending ratio: 2.46 ml/1.64 ml/0.90 ml) was added to the alkoxide emulsion. The resulting mixture was stirred at 40° C. for one hour, and hydrolysis of alkoxide was thus performed. In this manner, a plurality of particles were obtained.

Thereafter, centrifugal separation processing was performed with a centrifugal separator under conditions of 5,000 rpm and 10 minutes, and the particles were thus separated and recovered. Also, the operations for dispersing the recovered particles in ethanol and performing the centrifugal separation processing under conditions of 5,000 rpm and 10 minutes were carried out two times. The particles were thus washed. Further, the particles were dried at 80° C. for 24 hours with a drier, and the sintering particles were thereby obtained.

Observation of the sintering particles with the scanning type electron microscope (SEM) revealed that the sintering particles were constituted of approximately spherical fine particles having approximately identical particle sizes (particle diameters: approximately 0.5 μm). The sintering particles thus had uniform particle sizes and uniform particle shapes.

The sintering particles having thus been obtained were subjected to uniaxial compression molding processing (preliminary molding) at a molding pressure of 10 MPa, and the preliminarily molded body having thus been obtained was then subjected to CIP processing at 140 MPa. In this manner, a compression molded body (the particle molded body) taking on the form of a pellet (a circular cylinder-shaped pellet) having a diameter of 10 mm and a height of 5 mm was obtained.

The compression molded body (the particle molded body) having thus been obtained was subjected to a preliminary firing process in an electric furnace under an air atmosphere. Specifically, with the preliminary firing process, the temperature of the compression molded body was raised to 1,400° C. at a temperature rise rate of 500° C./hr and was kept at 1,400° C. for two hours, and the compression molded body was then cooled to a temperature of 1,000° C. at a temperature fall rate of 500° C./hr and was then subjected to natural furnace cooling.

Thereafter, instead of the preliminarily sintered body being subjected to the grinding processing, the preliminarily sintered body having thus been obtained was subjected to a final firing process in an electric furnace, which was capable of performing vacuum firing, under a vacuum atmosphere (1.0×10⁻³ Pa). Specifically, with the final firing process, the temperature of the preliminarily sintered body was raised to 1,750° C. at a temperature rise rate of 500° C./hr and was kept at 1,750° C. for 10 hours, and the preliminarily sintered body was then cooled to a temperature of 1,000° C. at a temperature fall rate of 500° C./hr and was then subjected to natural furnace cooling. Further, opposite surfaces of the thus obtained finally fired body were polished. In this manner, the polycrystal sintered body of Eu:YAG, in which the Eu doping concentration had been set at the desired value, was obtained.

The thus obtained polycrystal sintered body exhibited good transparency characteristics. It was thus confirmed that, with the process of Example 3, the transparent ceramic material having good transparency characteristics required of the solid laser medium, or the like, was capable of being obtained.

The thus obtained polycrystal sintered body was ground and subjected to the XRD measurement in the same manner as that in Example 1. It was confirmed that the diffraction peak perfectly coincided with the diffraction peak of JCPDS#33-0040 (YAG cubic crystal), and that the sample had the single phase structure.

Observation with the SEM revealed that the thus obtained polycrystal sintered body was constituted of an aggregate of approximately spherical crystal particles having approximately identical sizes (crystal particles diameters: approximately 4 μm). The crystal particles constituting the polycrystal sintered body thus had uniform particle sizes and uniform particle shapes.

### Modification of Example 3

The particles described above, which were obtained with the alkoxide emulsion technique and were to be used for the sintering, may be subjected to decarburization with, for example, heat processing at 600° C. for 12 hours, and amorphous particles substantially constituted of Y, Al, Eu, and O alone may thus be obtained and used as the sintering particles. Alternatively, the amorphous particles described above may further be converted into polycrystal particles with, for example, heat processing at 1,200° C. for two hours, and the polycrystal particles substantially constituted of Y, Al, Eu, and O alone may thus be obtained and used as the sintering particles. The inventors have confirmed that, in cases where the sintering particles having been obtained in the manner described above are used, the polycrystal sintered body of Eu:YAG having good transparency characteristics are capable of being obtained as in Example 3.

### Example 4

A 20% Eu:YAG polycrystal sintered body (a transparent ceramic material) was prepared in the manner described below.

Firstly, sintering particles were prepared with the hydrothermal synthesis technique.

Specifically, 3.613 g of yttrium oxide (Y₂O₃) particles (purity: 99.99%) was weighed out accurately and introduced into a beaker. An excess of aqueous concentrated nitric acid solution was then added slowly into the beaker. The resulting mixture was stirred with heating, and yttrium oxide was thus perfectly dissolved in the aqueous concentrated nitric acid solution. Thereafter, the resulting solution was subjected to evaporation to dryness. After cooling to the normal temperatures, a small quantity of an aqueous nitric acid solution (e.g., two or three droplets of 35% concentrated nitric acid) and 3.569 g of europium nitrate hexahydrate (Eu(NO₃)₃.6H₂O) were added, and the resulting mixture was stirred. In this manner, 30 ml to 50 ml of aqueous solution (an aqueous Y+Eu solution) containing the Y ions and the Eu ions was prepared.

Also, 13.334 g of anhydrous aluminum chloride (AlCl₃) particles (purity: 99.99%) was weighed out accurately and was slowly added into a different beaker containing water. The resulting mixture was stirred, and anhydrous aluminum chloride was thus dissolved perfectly in water. In this manner, 30 ml to 50 ml of aqueous solution (an aqueous Al solution) containing the Al ions was prepared.

Further, an aqueous high-concentration solution (99.99%) of potassium hydroxide (KOH) was prepared in a different beaker.

After the three beakers described above had been prepared, the aqueous Y+Eu solution and the aqueous Al solution were mixed together. Thereafter, the aqueous high-concentration KOH solution was added little by little to the resulting mixed solution with stirring, while a pH meter was being watched. The mixed solution gelled in accordance with the alteration of the pH value, and the stirring was continued. At the time at which the pH value became equal to 12.0, the addition of the aqueous high-concentration KOH solution was ceased. In this manner, a raw material liquid (pH=12.0, 200 ml) for hydrothermal synthesis reaction was prepared.

The raw material liquid having thus been prepared was loaded into an autoclave (supplied by Hastelloy Co.) and was caused to undergo the hydrothermal reaction at 360° C. for two hours with stirring in a reaction vessel having an internal surface having been subjected to platinum lining processing.

After the reaction was finished, the reaction liquid was transferred into a beaker, and a decantation process for adding hot water and discharging a supernatant liquid alone was iterated at least ten times. Finally, a reaction precipitate was collected by filtration, and the firing particles were thereby obtained. The firing particles contained moisture and was subjected to a next process without a particular drying operation being carried out.

A part of the reaction precipitate having been obtained from the hydrothermal synthesis reaction was not subjected to the production of a polycrystal sintered body and was subjected to evaluation after being dried. The particles having been obtained with the drying of the reaction precipitate were subjected to the XRD measurement. It was confirmed that the diffraction peak perfectly coincided with the diffraction peak of JCPDS#33-0040 (YAG cubic crystal), and that the particles had the single phase structure. Also, SEM observation revealed that the particles were constituted of rhombic dodecahedral-shaped fine particles having approximately identical particle sizes (particle diameters: approximately 8 μm). The particles thus had uniform particle sizes and uniform particle shapes.

As a dispersion medium, 10 ml of ethanol was added to and mixed with approximately 5 g of the aforesaid firing particles having not been dried. The resulting mixture was introduced into a vessel having a markedly smooth bottom surface, and fine particles were allowed to be precipitated slowly. In lieu of ethanol, polyvinyl butyral, or the like, may be used as the dispersion medium.

Thereafter, a supernatant liquid was removed gently, and the fine particles were subjected to natural drying. In this manner, a pancake-like particle molded body was obtained. In lieu of the processing described above being performed, after the supernatant liquid had been removed gently, the vessel may be located on an antivibration mount and subjected to drying under reduced pressure, and a pancake-like particle molded body may thus obtained.

Thereafter, the particle molded body having thus been obtained was subjected to a firing process in an electric furnace, which was capable of performing vacuum firing, under a vacuum atmosphere (1.0×10⁻³ Pa). Specifically, with the firing process, the temperature of the particle molded body was raised to 1,750° C. at a temperature rise rate of 500° C./hr and was kept at 1,750° C. for five hours, and the particle molded body was then cooled to a temperature of 1,000° C. at a temperature fall rate of 500° C./hr and was then subjected to natural furnace cooling. Further, opposite surfaces of the thus obtained fired body were polished. In this manner, the polycrystal sintered body of Eu:YAG, in which the Eu doping concentration had been set at the desired value, was obtained.

The thus obtained polycrystal sintered body exhibited good transparency characteristics. It was thus confirmed that, with the process of Example 4, the transparent ceramic material having good transparency characteristics required of the solid laser medium, or the like, was capable of being obtained.

Observation with the SEM revealed that the thus obtained polycrystal sintered body was constituted of an aggregate of approximately rhombic dodecahedral crystal particles having approximately identical sizes (crystal particles diameters: approximately 8.5 μm). The crystal particles constituting the polycrystal sintered body thus had uniform particle sizes and uniform particle shapes, and the polycrystal sintered body had a high space filling rate.

In Example 4, the firing particles constituted of the fine particles having the rhombic dodecahedral shapes were prepared. In cases where the reaction conditions (the temperature, the time, and the like) for the hydrothermal reaction were altered, firing particles constituted of fine particles having the truncated octahedral shapes were capable of being prepared. (Reference may be made to FIGS. 4A, 4B, 4C, and 4D.)

### Example 5

A 10% Eu:YAG polycrystal sintered body (a transparent ceramic material) was prepared in the manner described below.

Firstly, Y₂O₃ particles (purity: 99.9%), α-Al₂O₃ particles (purity: 99.99%), and Eu₂O₃ particles (purity: 99.99%) were weighed out in quantities such that a desired composition might be obtained. The raw material particles described above, 100 ml of ethyl alcohol, and 150 10 mm-diameter alumina balls were put into a pot mill and were subjected to wet mixing processing for 12 hours.

Thereafter, the alumina balls were removed, and ethyl alcohol was removed from the resulting mixed particle slurry by use of a rotary evaporator. The mixed particles were then dried at a temperature of 100° C. for 12 hours. After the resulting dry particles had been slightly unfastened in a mortar, the thus obtained dry particles were passed through a 100-mesh sieve and then through a 200-mesh sieve. The particles having passed through the 200-mesh sieve were subjected to molding processing. The thus obtained particles for the molding processing were subjected to uniaxial compression molding processing at a molding pressure of 10 MPa and thus molded into a pellet (a circular cylinder-shaped pellet) having a diameter of 10 mm and a height of 5 mm. Further, the molded body having thus been obtained was vacuum packed and subjected to CIP processing at an isotactic pressure of 140 MPa.

The compression molded body having thus been obtained was subjected to a preliminary firing process in an electric furnace under an air atmosphere. Specifically, with the preliminary firing process, the temperature of the compression molded body was raised to 1,200° C. at a temperature rise rate of 500° C./hr and was kept at 1,200° C. for two hours, and the compression molded body was then cooled to a temperature of 1,000° C. at a temperature fall rate of 500° C./hr and was then subjected to natural furnace cooling.

The preliminarily sintered body having thus been obtained was subjected to a final firing process in the electric furnace under an air atmosphere. Specifically, with the final firing process, the temperature of the preliminarily sintered body was raised to 1,700° C. at a temperature rise rate of 500° C./hr and was kept at 1,700° C. for two hours, and the preliminarily sintered body was then cooled to a temperature of 1,000° C. at a temperature fall rate of 500° C./hr and was then subjected to natural furnace cooling. In this manner, the polycrystal sintered body of 10% Eu:YAG was obtained.

<Observation with Scanning Electron Microscope (SEM)>

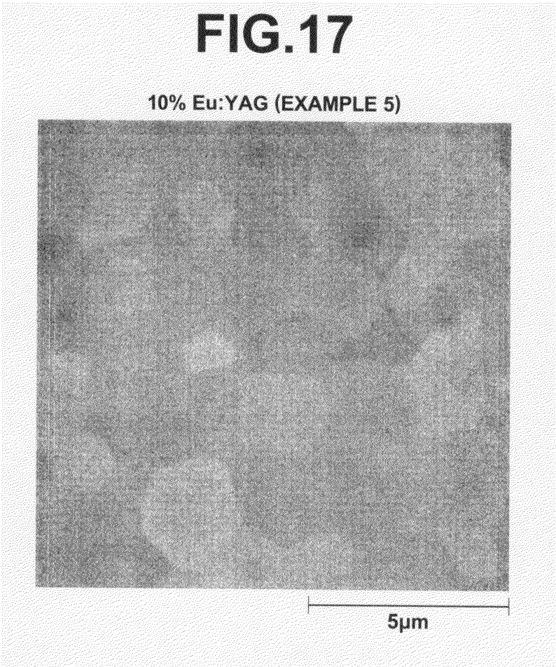

The surface of the polycrystal sintered body was polished, and the polycrystal sintered body was subjected to observation of a cross-section with a scanning electron microscope (SEM). An SEM cross-section photograph (Backscattered electron image) as illustrated in FIG. 17 was obtained. It was revealed that the high-density sintered body was obtained and that the crystal particles had the non-uniform (random) particle sizes and the non-uniform (random) particle shapes.

### <Powder X-Ray Diffraction (XRD) Measurement>

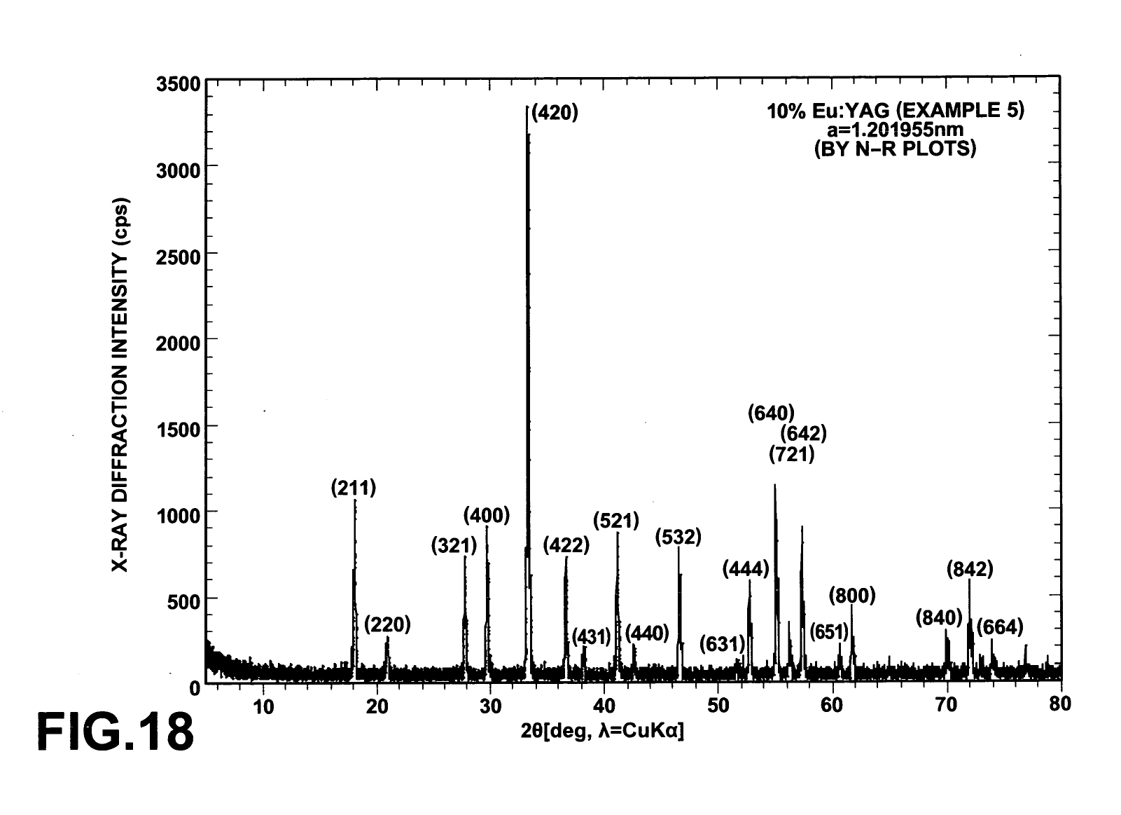

The XRD measurement was made in the same manner as that in Example 1. The XRD measurement result as illustrated in FIG. 18 was obtained. As for the sample, it was confirmed that the diffraction peak perfectly coincided with the diffraction peak of JCPDS#33-0040 (YAG cubic crystal), and that the sample had the single phase structure. Also, in the same manner as that in Example 1, the lattice constant was calculated in accordance with the result of the XRD measurement described above. It was found that the lattice constant a=1.201955 nm.

The lattice constant having thus been found was substituted into the correlation formula between the Eu concentration x (in units of mol %) at the A site and the lattice constant y, which formula was obtained in Example 1, (i.e., the formula y=1.2006+0.0001345x) (reference may be made to FIG. 10), and the Eu concentration was thus calculated. The Eu concentration was equal to 10.07%. The Eu concentration as designed was thus obtained. It was thus indicated, though indirectly, that the Eu concentration conforming to the loaded composition value was reflected upon the composition of the sintered body.

### <Luminescence Characteristics>

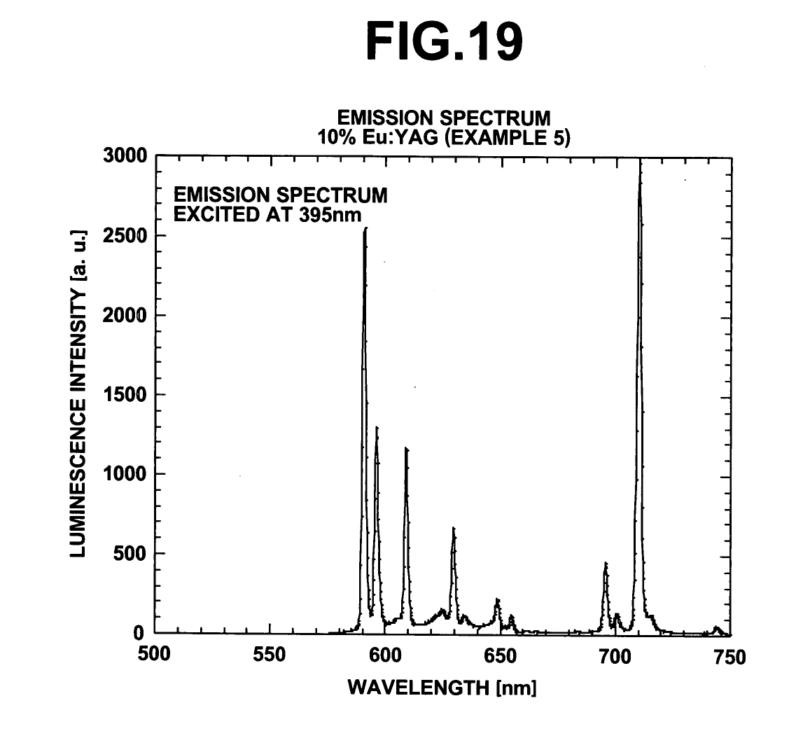

The emission spectrum (fluorescence spectrum) measurement was made in the same manner as that in Example 1. The wavelength λₑₓ of the exciting light was set at 395 nm, which was associated with the maximum luminescence intensity when the excitation spectrum was taken with respect to the Eu-doped compound. The emission spectrum as illustrated in FIG. 19 was obtained. As illustrated in FIG. 19, the sample described above exhibited the characteristics such that a plurality of luminescence peaks were found in the visible light wavelength range of 400 nm to 700 nm. Also, the luminescence peak of the highest intensity was found at a wavelength of 589 nm. The luminescence markedly stronger than the luminescence obtained with 1% Eu:YAG in Example 1 was found.

Ultraviolet light was irradiated from a mercury vapor lamp to the polycrystal sintered body having been obtained. Red, strong luminescence was observed with the naked eye.

### INDUSTRIAL APPLICABILITY

Each of the Eu-containing inorganic compound and the luminescent inorganic compound in accordance with the present invention is capable of being utilized appropriately in use applications, such as a solid laser medium and a fluorescent substance for white light emitting diodes.

What is claimed is:

1. An Eu-containing inorganic compound having a polycrystal structure, in which Eu has been doped into a matrix garnet type compound and has formed a solid solution in the matrix garnet type compound,
wherein a doping concentration of Eu occupying at an eight-coordination site of the garnet structure falls within the range of more than 0.5 mol % to 50.0 mol %, inclusive.

2. An Eu-containing inorganic compound as defined in claim 1 wherein the doping concentration of Eu occupying at the eight-coordination site of the garnet structure falls within the range of 5.0 mol % to 30.0 mol %.

3. An Eu-containing inorganic compound as defined in claim 1 wherein the Eu-containing inorganic compound substantially contains Eu alone as luminescence center ions.

4. An Eu-containing inorganic compound as defined in claim 1 wherein the Eu-containing inorganic compound is a garnet type compound, which may be represented by the general formula:
(A(III)₁₋ₓEuₓ)₃B(III)₂C(III)₃O₁₂
wherein each of the Roman numerals in the parentheses represents the valence number of ion,
A represents the element at the A site and represents at least one kind of element selected from the group consisting of Y, Sc, In, and trivalent rare earth elements of La, Ce, Pr, Nd, Sm, Gd, Tb, Dy, Ho, Er, Tm, Yb, and Lu,
B represents the element at the B site and represents at least one kind of element selected from the group consisting of Al, Sc, Ga, Cr, In, and trivalent rare earth elements of La, Ce, Pr, Nd, Sm, Eu, Gd, Tb, Dy, Ho, Er, Tm, Yb, and Lu,
C represents the element at the C site and represents at least one kind of element selected from the group consisting of Al and Ga, and
O represents the oxygen atom.

5. An Eu-containing inorganic compound as defined in claim 4 wherein the matrix garnet type compound is Y₃Al₅O₁₂.

6. A luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,
the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,
the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw takes an approximately predetermined value regardless of the doping concentration of the luminescent rare earth element,
the doping concentration of the luminescent rare earth element in the luminescent inorganic compound being set at a value falling within the range of the doping concentration of the luminescent rare earth element, in which range the light absorption intensity ratio Pf/Pw takes an approximately predetermined value regardless of the doping concentration of the luminescent rare earth element.

7. A luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,
the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,
the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw is approximately in proportion to the doping concentration of the luminescent rare earth element,
the doping concentration of the luminescent rare earth element in the luminescent inorganic compound being set at a value falling within the range of 0.5 Ne mol % to 2.0 Ne mol %, wherein Ne mol % represents the highest doping concentration of the luminescent rare earth element in the range of the doping concentration of the luminescent rare earth element, in which range the light absorption intensity ratio Pf/Pw is approximately in proportion to the doping concentration of the luminescent rare earth element.

8. A process for producing a luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,
the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,
the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw takes an approximately predetermined value regardless of the doping concentration of the luminescent rare earth element,
the process comprising the step of: setting the doping concentration of the luminescent rare earth element in the luminescent inorganic compound at a value falling within the range of the doping concentration of the luminescent rare earth element, in which range the light absorption intensity ratio Pf/Pw takes an approximately predetermined value regardless of the doping concentration of the luminescent rare earth element.

9. A process for producing a luminescent inorganic compound, which contains luminescence center ions capable of being excited by irradiation of exciting light and capable of producing luminescence having at least one luminescence peak wavelength in a visible light wavelength region of 400 nm to 700 nm, and which contains substantially one kind of luminescent rare earth element alone as the luminescence center ions,
the luminescent inorganic compound having characteristics such that:
an excitation spectrum, which represents a luminescence intensity at the highest luminescence peak wavelength within the visible light wavelength region with respect to excitation wavelengths, has a plurality of excitation peak wavelengths in the wavelength region shorter than 470 nm,
the luminescent inorganic compound having characteristics such that:
in cases where a doping concentration of the luminescent rare earth element is set at various different values, and calculation is made to find a light absorption intensity ratio Pf/Pw between two excitation peak wavelengths, which are associated with the highest luminescence intensity and the second highest luminescence intensity among the plurality of excitation peak wavelengths in the wavelength region shorter than 470 nm, wherein Pf represents the light absorption intensity at the excitation peak wavelength on a long wavelength side when the two excitation peak wavelengths, which are associated with the highest luminescence intensity and the second highest luminescence intensity, are compared with each other, and wherein Pw represents the light absorption intensity at the excitation peak wavelength on a short wavelength side when the two excitation peak wavelengths, which are associated with the highest luminescence intensity and the second highest luminescence intensity, are compared with each other,
the luminescent inorganic compound exhibits a range of the doping concentration of the luminescent rare earth element, in which range the light absorption intensity ratio Pf/Pw is approximately in proportion to the doping concentration of the luminescent rare earth element,
the process comprising the step of: setting the doping concentration of the luminescent rare earth element in the luminescent inorganic compound at a value falling within the range of 0.5 Ne mol % to 2.0 Ne mol %, wherein Ne mol % represents the highest doping concentration of the luminescent rare earth element in the range of the doping concentration of the luminescent rare earth element, in which range the light absorption intensity ratio Pf/Pw is approximately in proportion to the doping concentration of the luminescent rare earth element.

10. A luminescent composition, containing an Eu-containing inorganic compound as defined in claim 1.

11. A luminescent composition, containing a luminescent inorganic compound as defined in claim 6.

12. A luminescent composition, containing a luminescent inorganic compound as defined in claim 7.

13. A luminescent body, containing an Eu-containing inorganic compound as defined in claim 1, the luminescent body taking on the form of a molded body having been formed into a predetermined shape.

14. A luminescent body, containing a luminescent inorganic compound as defined in claim 6, the luminescent body taking on the form of a molded body having been formed into a predetermined shape.

15. A luminescent body, containing a luminescent inorganic compound as defined in claim 7, the luminescent body taking on the form of a molded body having been formed into a predetermined shape.

16. A luminescent body as defined in claim 13 wherein the molded body is a polycrystal sintered body, which is obtained from sintering processing performed on a particle molded body, the particle molded body having been obtained from processing, in which at least one kind of particles containing constituents of the Eu-containing inorganic compound are molded into a predetermined shape.

17. A luminescent body as defined in claim 14 wherein the molded body is a polycrystal sintered body, which is obtained from sintering processing performed on a particle molded body, the particle molded body having been obtained from processing, in which at least one kind of particles containing constituents of the luminescent inorganic compound are molded into a predetermined shape.

18. A luminescent body as defined in claim 15 wherein the molded body is a polycrystal sintered body, which is obtained from sintering processing performed on a particle molded body, the particle molded body having been obtained from processing, in which at least one kind of particles containing constituents of the luminescent inorganic compound are molded into a predetermined shape.

19. A luminescent body as defined in claim 16 wherein the molded body is constituted of an aggregate of a plurality of crystal particles having approximately identical particle sizes and approximately identical particle shapes, and the particle shapes of the crystal particles are polyhedral shapes such that the crystal particles alone are capable of filling a space approximately closely.

20. A luminescent body as defined in claim 17 wherein the molded body is constituted of an aggregate of a plurality of crystal particles having approximately identical particle sizes and approximately identical particle shapes, and the particle shapes of the crystal particles are polyhedral shapes such that the crystal particles alone are capable of filling a space approximately closely.

21. A luminescent body as defined in claim 18 wherein the molded body is constituted of an aggregate of a plurality of crystal particles having approximately identical particle sizes and approximately identical particle shapes, and the particle shapes of the crystal particles are polyhedral shapes such that the crystal particles alone are capable of filling a space approximately closely.

22. A luminescent body as defined in claim 19 wherein the crystal particles have the particle shapes selected from the group consisting of cubic shapes, truncated octahedral shapes, and rhombic dodecahedral shapes.

23. A luminescent body as defined in claim 20 wherein the crystal particles have the particle shapes selected from the group consisting of cubic shapes, truncated octahedral shapes, and rhombic dodecahedral shapes.

24. A luminescent body as defined in claim 21 wherein the crystal particles have the particle shapes selected from the group consisting of cubic shapes, truncated octahedral shapes, and rhombic dodecahedral shapes.

25. A luminescent body as defined in claim 16 wherein the particles are synthesized with a technique selected from the group consisting of a hydrothermal synthesis technique and an alkoxide emulsion technique.

26. A luminescent body as defined in claim 17 wherein the particles are synthesized with a technique selected from the group consisting of a hydrothermal synthesis technique and an alkoxide emulsion technique.

27. A luminescent body as defined in claim 18 wherein the particles are synthesized with a technique selected from the group consisting of a hydrothermal synthesis technique and an alkoxide emulsion technique.

28. A luminescent body as defined in claim 13 wherein the molded body is a molded body, in which particles of the Eu-containing inorganic compound have been bound together by a resin binder.

29. A luminescent body as defined in claim 14 wherein the molded body is a molded body, in which particles of the luminescent inorganic compound have been bound together by a resin binder.

30. A luminescent body as defined in claim 15 wherein the molded body is a molded body, in which particles of the luminescent inorganic compound have been bound together by a resin binder.

31. A luminescent body as defined in claim 13 wherein the Eu-containing inorganic compound is a laser substance capable of producing a laser beam by being excited by exciting light.

32. A luminescent body as defined in claim 14 wherein the luminescent inorganic compound is a laser substance capable of producing a laser beam by being excited by exciting light.

33. A luminescent body as defined in claim 15 wherein the luminescent inorganic compound is a laser substance capable of producing a laser beam by being excited by exciting light.

34. A solid laser device, comprising:
i) a solid laser medium constituted of a luminescent body as defined in claim 31, and
ii) an exciting light source for producing the exciting light to be irradiated to the solid laser medium.

35. A solid laser device, comprising:
i) a solid laser medium constituted of a luminescent body as defined in claim 32, and
ii) an exciting light source for producing the exciting light to be irradiated to the solid laser medium.

36. A solid laser device, comprising:
i) a solid laser medium constituted of a luminescent body as defined in claim 33, and
ii) an exciting light source for producing the exciting light to be irradiated to the solid laser medium.

37. A solid laser device as defined in claim 34 wherein the exciting light source is constituted of a semiconductor laser, which has an oscillation peak wavelength falling within the range of 350 nm to 480 nm.

38. A solid laser device as defined in claim 35 wherein the exciting light source is constituted of a semiconductor laser, which has an oscillation peak wavelength falling within the range of 350 nm to 480 nm.

39. A solid laser device as defined in claim 36 wherein the exciting light source is constituted of a semiconductor laser, which has an oscillation peak wavelength falling within the range of 350 nm to 480 nm.

40. A solid laser device as defined in claim 37 wherein the exciting light source is constituted of a semiconductor laser selected from the group consisting of a GaN type of semiconductor laser and a ZnO type of semiconductor laser.

41. A solid laser device as defined in claim 38 wherein the exciting light source is constituted of a semiconductor laser selected from the group consisting of a GaN type of semiconductor laser and a ZnO type of semiconductor laser.

42. A solid laser device as defined in claim 39 wherein the exciting light source is constituted of a semiconductor laser selected from the group consisting of a GaN type of semiconductor laser and a ZnO type of semiconductor laser.

43. A solid laser device as defined in claim 34 wherein the solid laser device further comprises a wavelength converting element for converting a wavelength of the laser beam having been produced by the solid laser medium.

44. A solid laser device as defined in claim 35 wherein the solid laser device further comprises a wavelength converting element for converting a wavelength of the laser beam having been produced by the solid laser medium.

45. A solid laser device as defined in claim 36 wherein the solid laser device further comprises a wavelength converting element for converting a wavelength of the laser beam having been produced by the solid laser medium.

46. A light emitting device, comprising:
a luminescent body as defined in claim 13, and
ii) an exciting light source for producing exciting light to be irradiated to the luminescent body.

47. A light emitting device, comprising:
a luminescent body as defined in claim 14, and
ii) an exciting light source for producing exciting light to be irradiated to the luminescent body.

48. A light emitting device, comprising:
a luminescent body as defined in claim 15, and
ii) an exciting light source for producing exciting light to be irradiated to the luminescent body.
